(19) United States
(12) Patent Application Publication
(10) Pub. No.: US 2011/0106280 A1
(43) Pub. Date: May 5, 2011

(54) AUTOMATED BATTERY SCANNING, REPAIR, AND OPTIMIZATION

(76) Inventor: BRUCE ERIC ZEIER, Romoland, CA (US)

(21) Appl. No.: 12/917,806

(22) Filed: Nov. 2, 2010

Related U.S. Application Data
(60) Provisional application No. 61/257,619, filed on Nov. 3, 2009.
(60) Provisional application No. 61/330,357, filed on May 2, 2010.

(51) Int. Cl. G06F 17/00

(52) U.S. Cl. 700/90

(57) ABSTRACT

A method of servicing a battery may include connecting a battery to a battery servicing apparatus including an automated electronic system; measuring, by the automated electronic system, a first set of metrics associated with the a battery cell; selecting, automatically by the automated electronic system, a maintenance action based at least in part upon the measured first set of metrics; directing, by the automated electronic system, performance of the maintenance action on the battery cell by an ancillary device; and/or measuring, by the automated electronic system, a second set of metrics associated with the battery cell after performance of the maintenance action. The automated electronic system may be configured to gather data using one or more probes and/or clamps associated with the battery cell. The automated electronic system may include a memory configured to store data and/or a processing unit configured to direct operation of the ancillary device.

### CROSS-REFERENCE TO RELATED APPLICATIONS

This application claims the benefit of U.S. Provisional Application No. 61/257,619, filed Nov. 3, 2009, and titled “Battery Optimization Scanning System,” and U.S. Provisional Application No. 61/330,357, filed May 2, 2010, titled “Automated Battery Scanning, Repair and Optimization,” which are incorporated by reference.

### BACKGROUND

The present disclosure is directed to maintenance and repair of storage batteries and, more particularly, to automated scanning, repair, and optimization of lead-acid storage batteries.

### SUMMARY

Servicing of batteries is generally disclosed. In some example embodiments, a method of servicing a battery may include connecting a battery to a battery servicing apparatus, which may include an automated electronic system configured to gather data associated with at least one battery cell and/or to direct operation of at least one ancillary device. The automated electronic system may be operatively coupled to at least one probe at least partially immersed in electrolyte of the battery cell and/or at least one clamp operatively coupled to a plate of the battery cell, or a combination of immersed probes and clamps. The automated electronic system may include a memory configured to store data associated with the battery cell and/or a processing unit configured to direct operation of the ancillary device. The ancillary device may be configured to act on the battery cell. Then, a first set of metrics associated with the battery cell may be measured by the automated electronic system. The automated electronic system may automatically select at least one maintenance action based at least in part upon the measured first set of metrics. The automated electronic system may direct performance of the maintenance action on the battery cell by the ancillary device. Then, the automated electronic system may measure a second set of metrics associated with the battery cell after performance of the at least one maintenance action.

Servicing of batteries is generally disclosed. In some example embodiments, a method of maintaining a battery may include connecting a battery to a battery servicing apparatus. The battery servicing apparatus may include an automated electronic system configured to gather data associated with at least one battery cell and/or to direct operation of at least one ancillary device. The automated electronic system may be operatively coupled to at least one probe at least partially immersed in electrolyte of the battery cell and/or at least one clamp operatively coupled to a plate of the battery cell, or a combination of immersed probes and clamps. The automated electronic system may include a memory configured to store data associated with the battery cell and/or a processing unit configured to direct operation of the ancillary device. The ancillary device may be configured to perform at least one battery maintenance action on the battery cell. Then, the automated electronic system may measure data pertaining to at least one parameter associated with the battery cell. The automated electronic system may record the data. The automated electronic system may automatically analyze the data to determine whether an out of specification condition is associated with the battery cell.

Servicing of batteries is generally disclosed. In some example embodiments, a method of servicing a battery may include connecting a battery to a battery servicing apparatus, which may include an automated electronic system configured to gather data associated with at least one battery cell and/or to direct operation of at least one ancillary device. The automated electronic system may be operatively coupled to at least one probe at least partially immersed in electrolyte of the battery cell and/or at least one clamp operatively coupled to a plate of the battery cell, or a combination of immersed probes and clamps. The automated electronic system may include a memory configured to store data associated with the battery cell and/or a processing unit configured to direct operation of the ancillary device, which may be configured to perform a battery maintenance action on the battery cell. Then, the automated electronic system may measure a first set of data associated with a plurality of individual cells of the battery during at least one of normal operation and testing operation. The automated electronic system may automatically identify a first set of maintenance actions to be performed on the battery based at least in part upon analysis of the first set of data. The automated electronic system may automatically formulate a first set of commands corresponding to the first set of maintenance actions. Then, the automated electronic system may execute the first set of commands to direct the ancillary device to perform the first set of maintenance actions on the battery.

An example battery servicing apparatus may include an automated electronic system configured to gather data associated with at least one battery or battery cell and to direct operation of at least one ancillary device, where the ancillary device is configured to perform at least one battery maintenance action on the at least one battery or battery cell. The battery servicing apparatus may include one or more probes configured to be at least partially immersed in electrolyte of the at least one battery or battery cell and operatively connected to the automated electronic system, one or more clamps configured to be electrically coupled to plates of individual battery cells, or a combination of immersed probes and clamps, a memory configured to store the data associated with at least one battery or battery cell, and/or a processing unit configured to output at least one command for directing the operation of the at least one ancillary device based at least in part upon the data associated with at least one battery or battery cell. In some example embodiments, an automated electronic system may be operatively connected to a plurality of ancillary devices, where each of the ancillary devices is configured to perform a respective maintenance action on the at least one battery or battery cell as directed by the automated electronic system.

### BRIEF DESCRIPTION OF THE DRAWINGS

The detailed description refers to the following figures in which:

FIG. 1 is a block diagram of an example battery scanning, repair, and optimization system;

FIG. 2 is a cross-sectional view of an example battery cell probe;

FIG. 3 is a block diagram of an example battery charger master-slave configuration;

FIG. 4 is a block diagram illustrating an example battery service system including various ancillary devices;

FIG. 5 is a flow chart illustrating an example battery servicing procedure;

FIG. 6 is a cross-sectional view of two probes configured as an example liquid medium connection;

FIG. 7 is a block diagram of an example ancillary device connected to a battery;

FIG. 8 is a block diagram of an example acid adjustment system;

FIG. 9 is a block diagram of an alternative example acid adjustment system;

FIG. 10 is a block diagram of an example handheld battery scanning device;

FIG. 11 is a block diagram of an example smart probe;

FIG. 12 is a block diagram of an example battery service system;

FIG. 13 is a screen shot of an example scan module; and

FIG. 14 is a block diagram of an example computer system.

### DETAILED DESCRIPTION

The present disclosure includes, inter alia, exemplary automated battery scanning, repair, and/or optimization systems, devices, methods, and processes, referred to herein as scanning, repair, and optimization (SRO) systems, devices, methods, and processes.

Some exemplary SRO devices according to the present disclosure may be configured to perform one or more of the following: (1) measure and/or record the data associated with a battery and/or a battery's individual cell(s) during normal operation and/or testing mode operation (e.g., “scan”); (2) create and/or store information (e.g., sequenced instructions to ancillary device) associated with maintenance and/or repair of a battery and/or individual cell(s) (e.g., “commands”); (3) execute commands to effect maintenance and/or repair of a battery and/or individual cell(s), such as by using ancillary controlled devices (e.g., “control”); (4) analyze collected data (e.g., compare and/or categorize data associated with a battery and/or individual cell(s), calculation a qualitative performance factor, diagnose battery and/or cell deficiencies, predict battery and/or cell life expectancy and/or performance values); and/or (5) utilize results of data analysis to improve battery and/or individual cell performance capabilities.

The present disclosure refers to batteries and individual cells. As used herein “battery” and “battery array” include, but are not limited to: (1) a battery case including an individual internal cell, regardless of the voltage and/or amp-hour rating; (2) a battery case including at least two individual electrically interconnected cells, regardless of the individual and/or combined voltage or amp-hour rating; (3) a battery array including more than one battery case, regardless of the number of individual and/or interconnected cells and/or battery cases and irrespective of the connections therebetween.

The present disclosure contemplates that a battery including two or more series or parallel connected cells may be limited in power and/or capacity by the weakest of those cells. Example SRO processes according to the present disclosure may combine and/or compare information associated with individual cells to provide a comprehensive evaluation of the comparative capability of those cells within a battery cell array. For example, exemplary embodiments may consider the effect of individual cell performance on the combined operation of a multi-cell battery, may calculate a qualitative value useful for comparing cells, and/or may evaluate battery and/or cell performance and/or longevity based on the qualitative value associated with individual cells.

Example embodiments according to the present disclosure may allow detection and/or prediction of individual cell failures. For example, some exemplary SRO devices may be capable of providing alarm, indication, evaluation, or warning functions based upon data associated with each individual cell in a battery.

Some exemplary embodiments according to the present disclosure may interface the battery and/or cell data into a data protocol, thereby allowing transfer of the data across various communication networks, such as the Internet. For example, some embodiments may utilize a website based portal. In some example embodiments, web-based portals and/or other data interfaces may be used to develop a worldwide database that may provide statistical analysis of battery/charger combinations and resultant battery/cell efficiency ratings.

Individual cell data measured by some example SRO embodiments may include but is not limited to one or more of the following: (1) cell voltage measured across the entire cell; (2) cell voltage “P” measuring the positive plate voltage between the electrolyte and the positive cell terminal; (3) cell voltage “N” measuring the negative plate voltage between the electrolyte and the negative cell terminal; (4) cell electrolyte temperature; (5) cell impedance as measured across the entire cell (e.g., from positive terminal to negative terminal); (6) cell impedance “P” measuring the positive plate impedance between the electrolyte and the positive cell terminal; (7) cell impedance “N” measuring the negative plate impedance between the electrolyte and the negative cell terminal; (8) cell impedance as measured from the electrolyte of one adjacent cell to the electrolyte of another adjacent cell, or cells that may be combined in an array of adjacent cells, (9) cell electrolyte molecular acid concentration (MAC) (described below), (10) cell electrolyte fluid levels; (11) changes in various cell parameters as the cell is discharged; (12) changes in various cell parameters as a charge is applied to the cell; (13) changes in various cell parameters as a rapid sulfation elimination process (and/or other ancillary process) is applied to the cell; (14) vibration endured by an individual cell during at least a portion of its operational history; and/or (15) an Electrical Serviceability Index (described below).

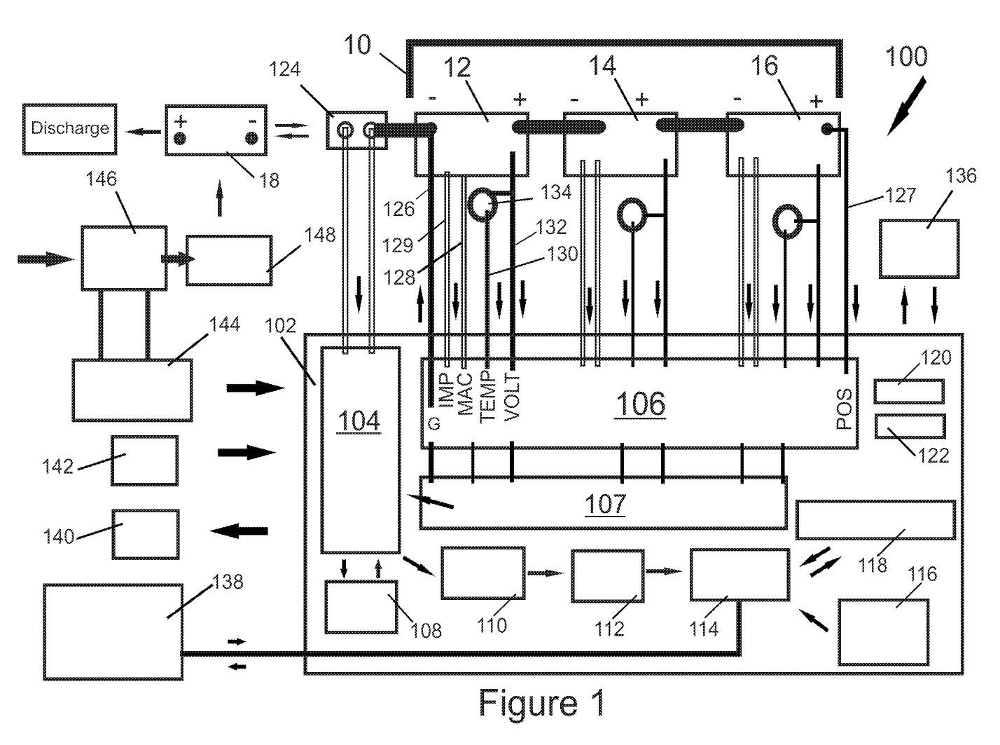

FIG. 1 is a block diagram of an example battery servicing apparatus, for example SRO system 100, associated with a battery 10, which may include a plurality of cells 12, 14, 16. Battery 10 may be electrically coupled with one or more other batteries 18 to form a battery array. An example automated electronic system, for example control module 102, may be operatively coupled to cells 12, 14, 16, such as using wiring, cables, and/or other electrical conductors.

An example control module 102 may include a processing unit, for example micro controller 104, a multiplexer 106 and/or an alternative device 107 (e.g., a relay panel and/or a switch panel), a memory 108, a transceiver 110, an isolator 112, a computer I/O 114, a vibration module 116, a carbon track module 118, a GPS locator 120, and/or a, RFID pinger 122. Micro controller 104 may be configured to sense DC amps using a sensing device 124, such as a shunt, an inductive DC control transformer clamp, and/or a clamp type Hall effect sensor.

In some example embodiments, the ground potential of battery 10 may be sensed by multiplexer 106 using a ground conductor 126. In some example embodiments, the positive potential of battery 10 may be sensed by multiplexer 106 using a positive potential conductor 127.

As discussed below, parameters associated with individual cells 12, 14, 16 may be sensed by multiplexer 106 via a MAC impedance line 128, an Impedance line 129, a temperature line 130, and/or a Voltage line 132. In some example embodiments, temperature line 130 and/or Voltage line 132 may be operatively coupled to a thermister 134 or other temperature sensor.

In some example embodiments, control module 102 may be operatively connected to one or more ancillary devices 136 (e.g., a charger, a de-sulfator, a load tester, etc.), which may also be operatively coupled to battery 10. Control module 102 may be operatively coupled to a computer 138, which may be provided integrally with or separately from control module 102. For example, computer 138 and control module 102 may be provided within a common housing and/or case, which may also include an integral display screen and/or input device. In some example embodiments, computer 138 may comprise micro controller 104. In some example embodiments, computer 138 may be configured to perform various control, monitoring, and/or calculating operations as described herein. Some example control modules 102 may include alarms 140 (e.g., audible and/or visible), outside air temperature sensors 142, and/or charger power measurement inputs 144. An example charger power measurement input 144 may include AC amps and/or AC Volts supplied to a charger 148 as measured by a measuring device 146.

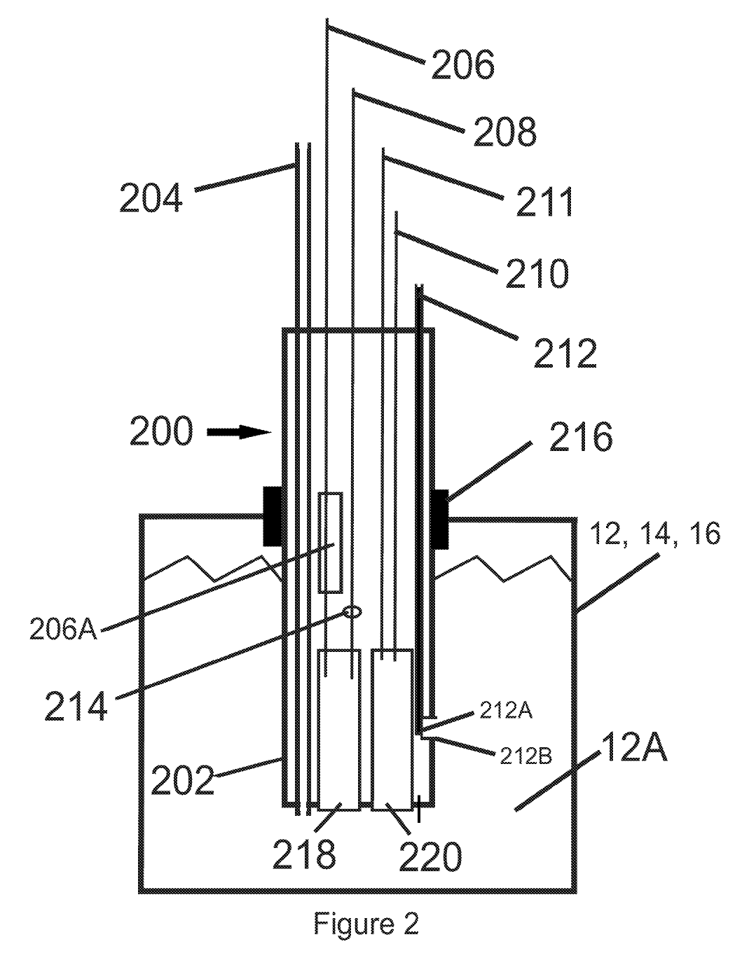

FIG. 2 is a cross-sectional view of an example battery cell probe 200, which may include a housing 202 (e.g., polypropylene and/or epoxy blended composite material) which may generally support other components. An example probe 200 may include a pipette 204, which may be used for acid adjustment as described below. Probe 200 may include various leads, such as lead 206 which may be used to measure voltage and/or electrolyte level, a lead 208 which may be used to measure temperature using a resistance temperature detector or thermistor 214, a lead 210 and a lead 211 which may be used to measure impedance or MAC, and/or an electrolyte level lead 212. An example probe 200 may be installed in a battery cell 12, 14, 16 through a vent cap 216 and/or a drilled hole and/or may be at least partially immersed in the electrolyte 12A of the battery cell 12, 14, 16. An example probe may include a plurality of conductive elements in electrical contact with the electrolyte 12A, such as electrodes 218, 220, which may be electrically connected to leads 206, 208, 210 and 211, respectively. In some example embodiments, one or more fuses 206A may electrically interpose one or more electrodes 218, 220 and their respective leads 206, 208, 210 and 211. In some example embodiments, an electrolyte level electrode 212A may be connected to electrolyte level lead 212 and/or may be at least partially exposed to electrolyte 12A via an opening 212B.

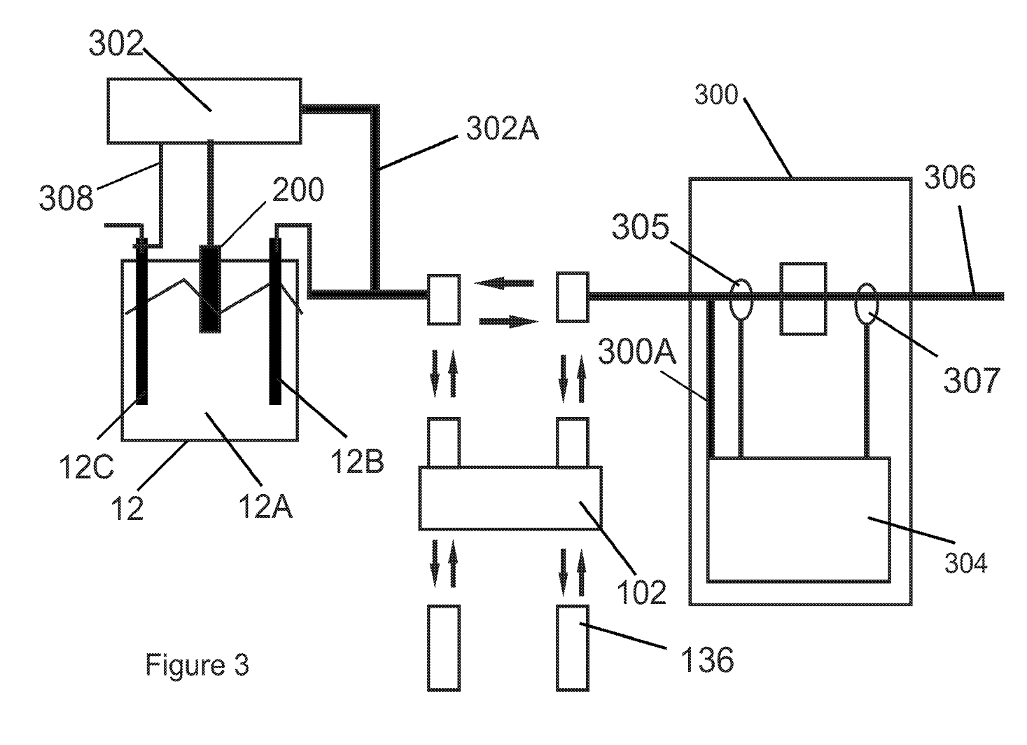

FIG. 3 is a block diagram of an example battery charger master-slave configuration. An example control module 102 may be operatively connected to a battery cell 12 and/or a battery charger 300, which may be coupled together to charge the battery cell 12. In some example embodiments, a Batt-smart module 302 may be operatively connected to battery cell 12 and/or may be configured to perform various monitoring and/or control functions discussed below. Batt-smart module 302 may be configured to communicate with and/or may be considered a component of control module 102. Batt-smart module 302 may be operatively connected to a probe 200 at least partially immersed in electrolyte 12A and/or a clamp 308 associated with one or more plates 12B, 12C of battery cell 12. Battery charger 300 may be configured to receive command and control signals from slave module 304, which may receive instructions from Batt-Smart module 302 and/or control module 102. Battery charger 300 may include an AC power inlet connection 306. In some example embodiments, Batt-smart module 302 may communicate with control module 102 at least partially over conductors associated with battery cell 12, battery charger 300, and/or both. Batt-smart module 302 may include a control frequency out connection 302A and/or slave module 304 may include a control frequency in connection 300A. Slave Module 304 may receive input data from Hall Effect Sensor or Ammeter Shunt 305 or 307, which is then transmitted to Batt-Smart module 302 and/or control module 102.

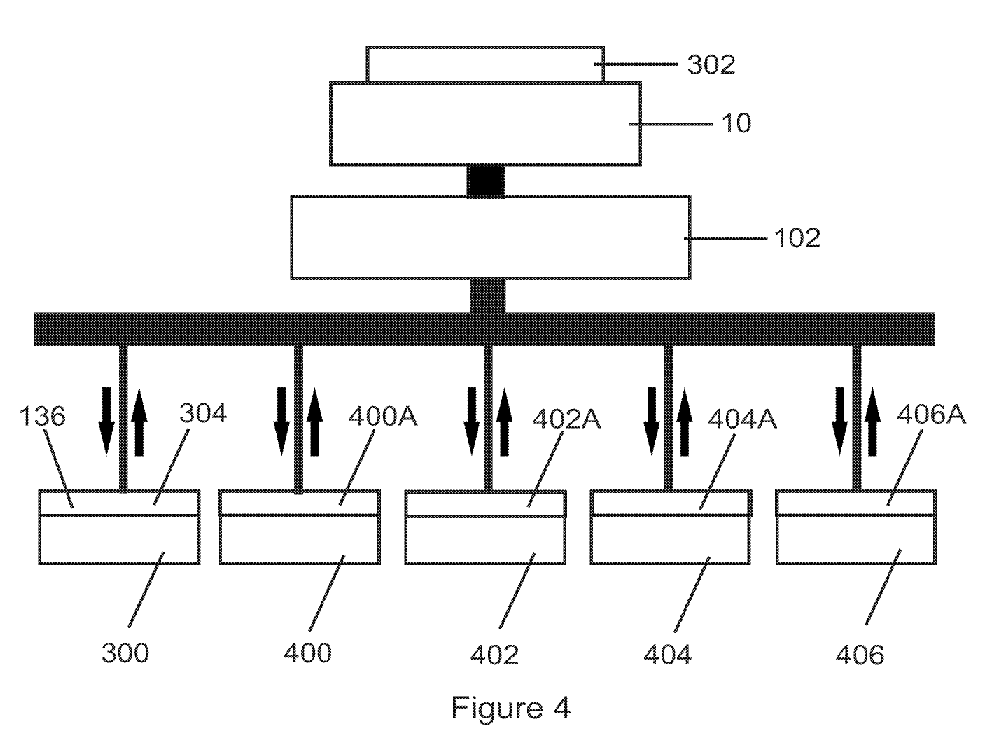

FIG. 4 is a block diagram illustrating an example battery service system including various ancillary devices. Control module 102 may be operatively connected to battery 10, which may be associated with a Batt-Smart module 302. Control module 102 may be operatively coupled to various ancillary devices 136, such as charger 300, a desulfation system 400, a load tester 402, an acid adjust module 404, and/or other optional ancillary devices 406. Individual ancillary devices 136 may be directly controllable by control module 102 and/or may be configured with a slave module to permit control by control module 102. For example, battery charger 300 may be provided with slave module 304, desulfation system may be provided with a slave module 400A, load tester 402 may be provided with a slave module 402A, acid adjust module 404 may be provided with slave module 404A, and/or other ancillary devices 406 may be provided with respective slave modules 406A.

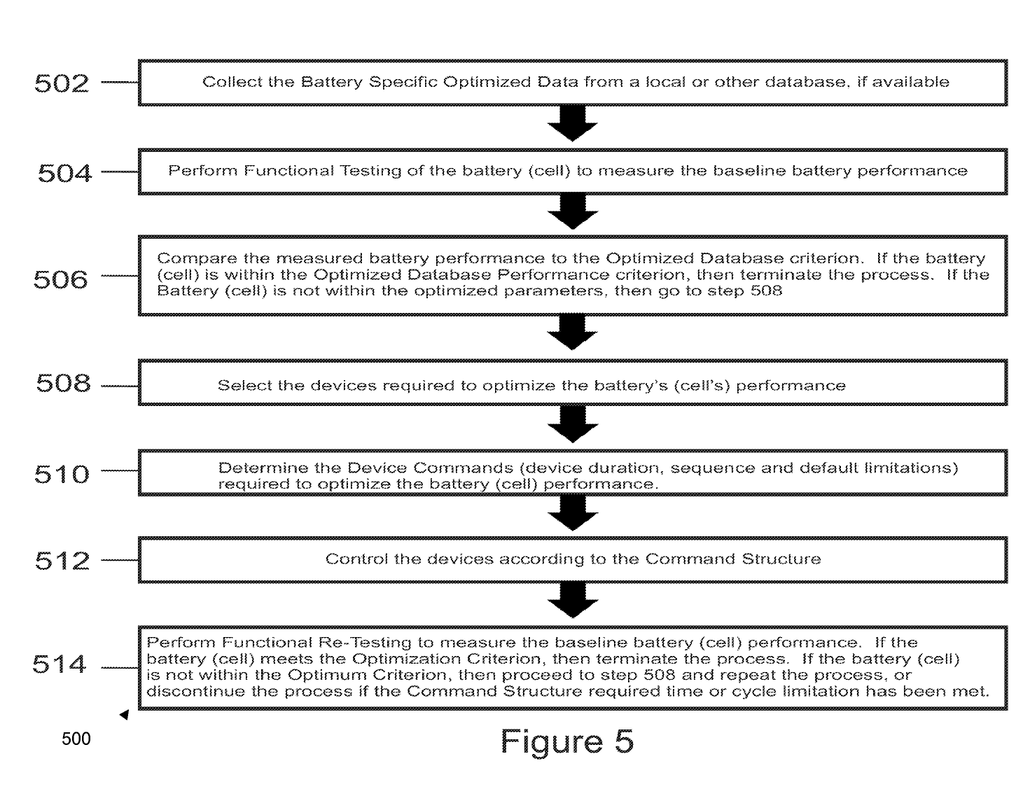

FIG. 5 is a flow chart illustrating an example battery servicing procedure 500. Operation 502 may include collecting battery-specific optimized data from a local or other database. Operation 504 may include performing functional testing of the battery to measure baseline battery performance. Operation 506 may include comparing the measured battery performance to the optimized database criterion. If the battery is within the optimized database performance criterion, then terminate the process. If the battery is not within the optimized parameters, then go to the next step. Operation 508 may include selecting the devices required to optimize the battery's performance Operation 510 may include determining the device commands (e.g., device duration, sequence, and/or default limitations) required to optimize the battery. Operation 512 may include controlling the devices according to the command structure. Operation 514 may include performing functional re-testing to measure the baseline battery performance. If the battery meets optimization criteria, then terminate the process. If the battery is not within the optimum criteria, then return to operation 508 and continue the servicing procedure, or discontinue the process if the Command Structure required time and/or cycle limitation has been met.

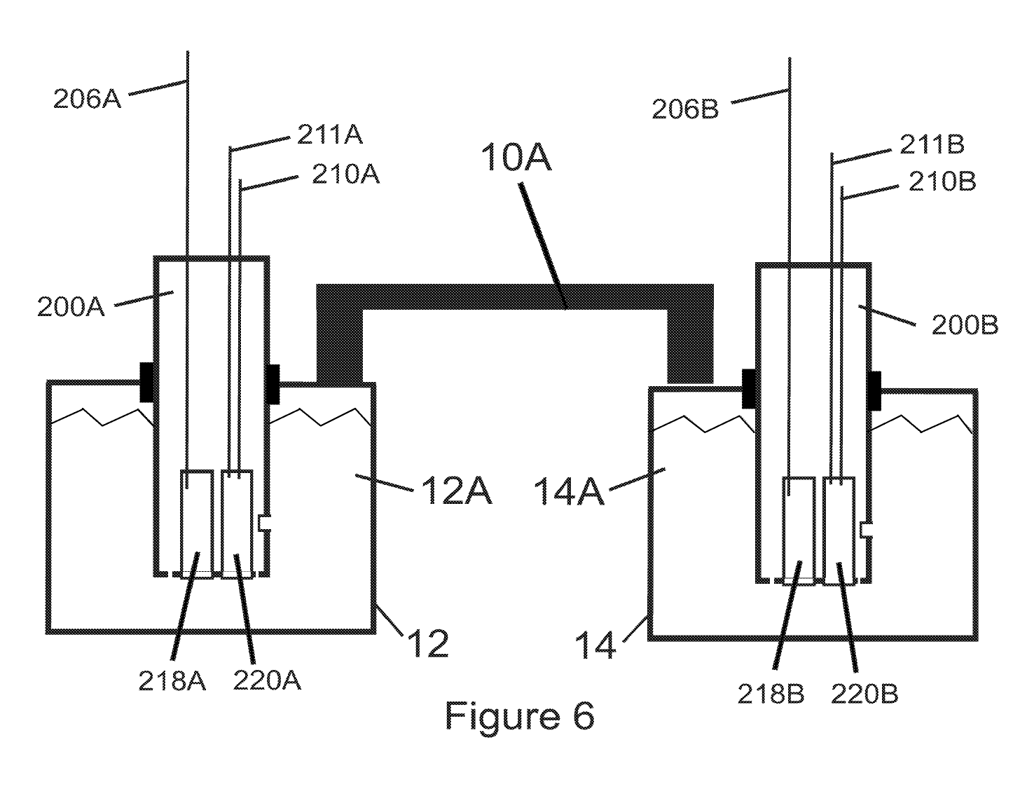

FIG. 6 is a cross-sectional view of two probes configured as a liquid medium connection. Probe 200A, which may be at least partially immersed in electrolyte 12A of cell 12, may be configured with Kelvin connection source leads 206A and 211A, and/or Kelvin connection sense leads 210A and 206A. Probe 200B, which may be at least partially immersed in electrolyte 14A of cell 14, may be configured with Kelvin connection source lead 206B and 211B, and/or Kelvin connection sense leads 210B and 206B.

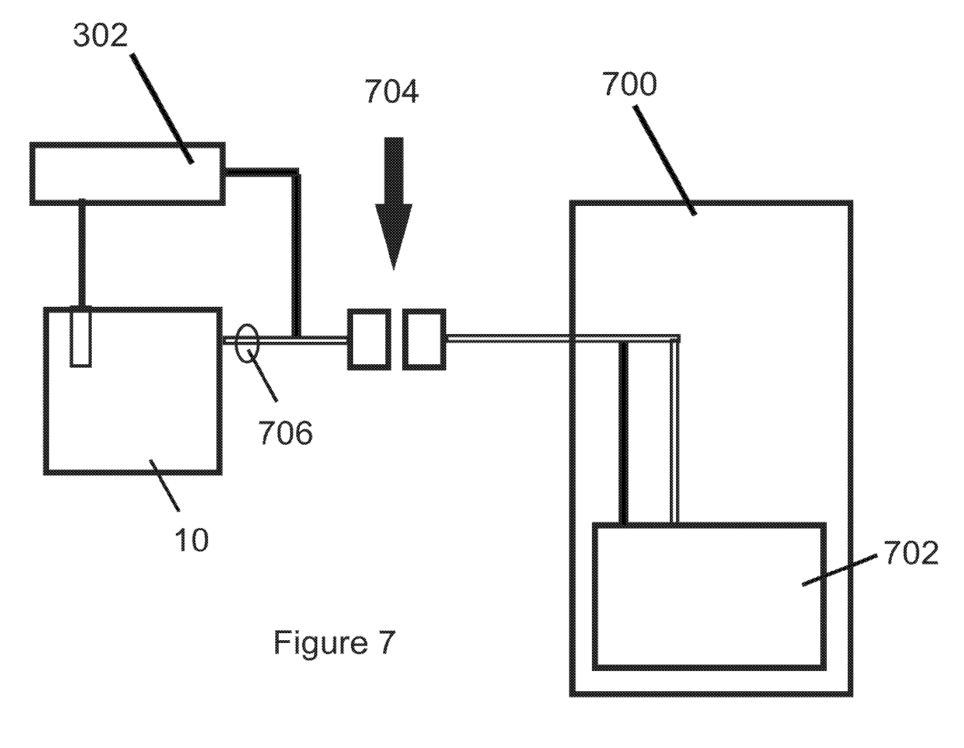

FIG. 7 is a block diagram of an example ancillary device connected to a battery. Batt-smart module 302 may be operatively connected to slave module 702 in discharge load tester 700. Control signals sent between Batt-smart module 302 and slave module 702 may direct at least some aspects of the operation of discharge load tester 700. Discharge load tester 700 may be selectively connected to battery 10 using connection 704. A sensor (e.g., a Hall effect sensor and/or Ammeter Shunt) 706 may allow the Batt-Smart module 302 to record discharge amperage during the operation of load tester 700.

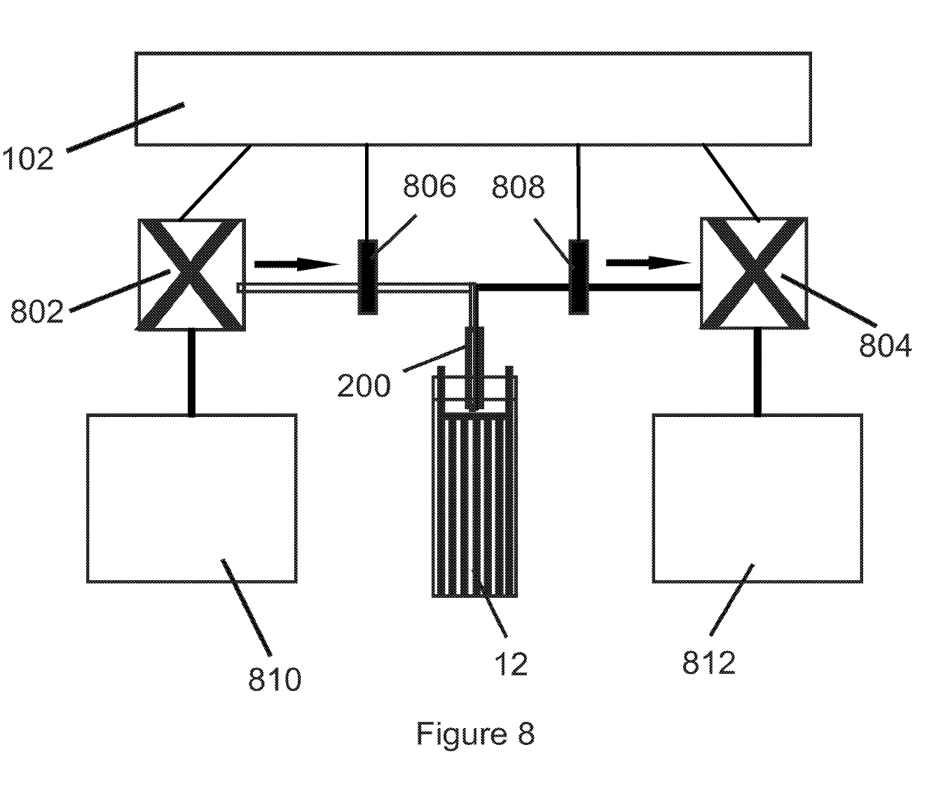

FIG. 8 is a block diagram of an example acid adjustment system 800, which may include an acid injection pump 802, an acid removal pump 804, an acid injection control valve 806, an acid removal control valve 808, a new acid storage tank 810, and/or an old, weak acid storage tank 812. Acid may be supplied to and/or removed from a battery cell 12 via a probe 200. Pumps 802, 804 and/or valves 806, 808 may be controlled by control module 102.

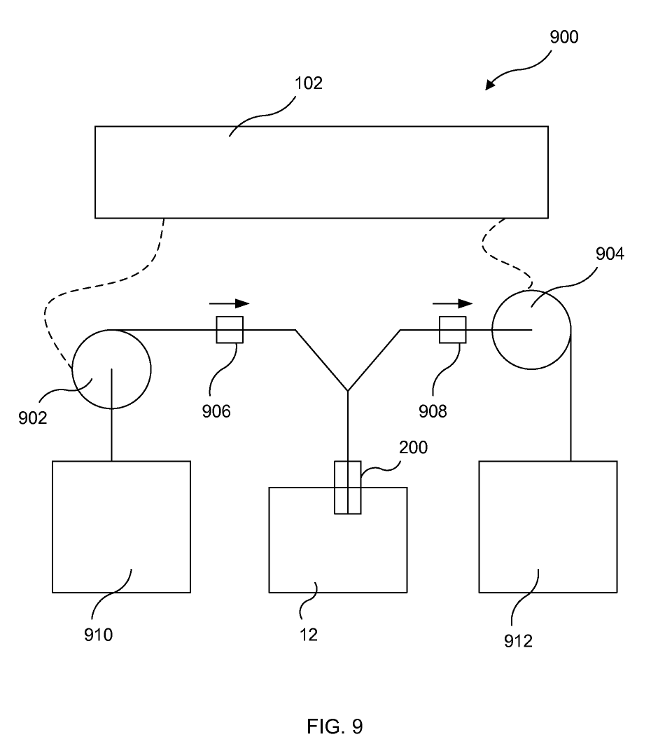

FIG. 9 is a block diagram of an alternative acid adjustment system 900, which may include an acid injection pump 902, an acid removal pump 904, an acid injection check valve 906, an acid removal check valve 908, a new acid storage tank 910, and/or an old, weak acid storage tank 912. Acid may be supplied to and/or removed from a battery cell 12 via a probe 200. Pumps 902, 904 may be controlled by control module 102.

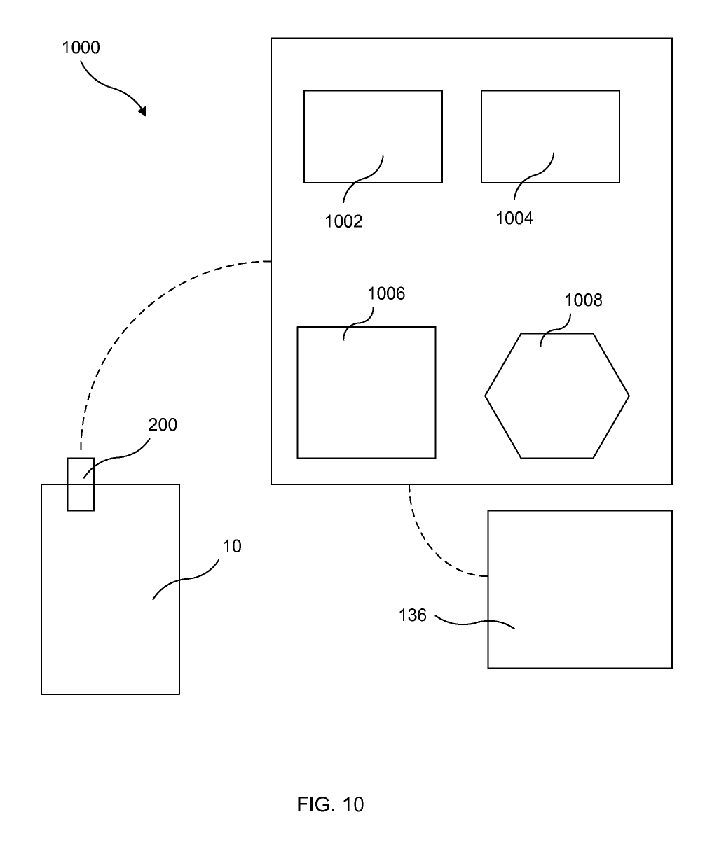

FIG. 10 is a block diagram of an example handheld battery scanning device 1000, which may be operatively connected to a battery 10 (and/or cells 12, 14, 16) via a probe 200 and/or to various controlled modules associated with ancillary devices 136. Handheld battery scanning device 1000 may include a circuit board 1002, a processor 1004, an input/output device 1006, and/or software 1008.

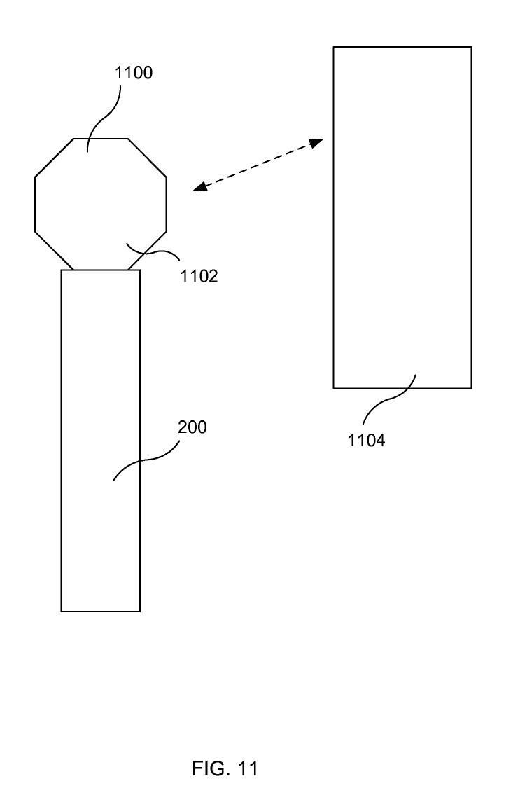

FIG. 11 is a block diagram of an example smart probe 1100, which may include a probe 200 as described above and circuitry 1102 configured to sense, record, and/or communicate to an external device 1104 data pertaining to a battery cell.

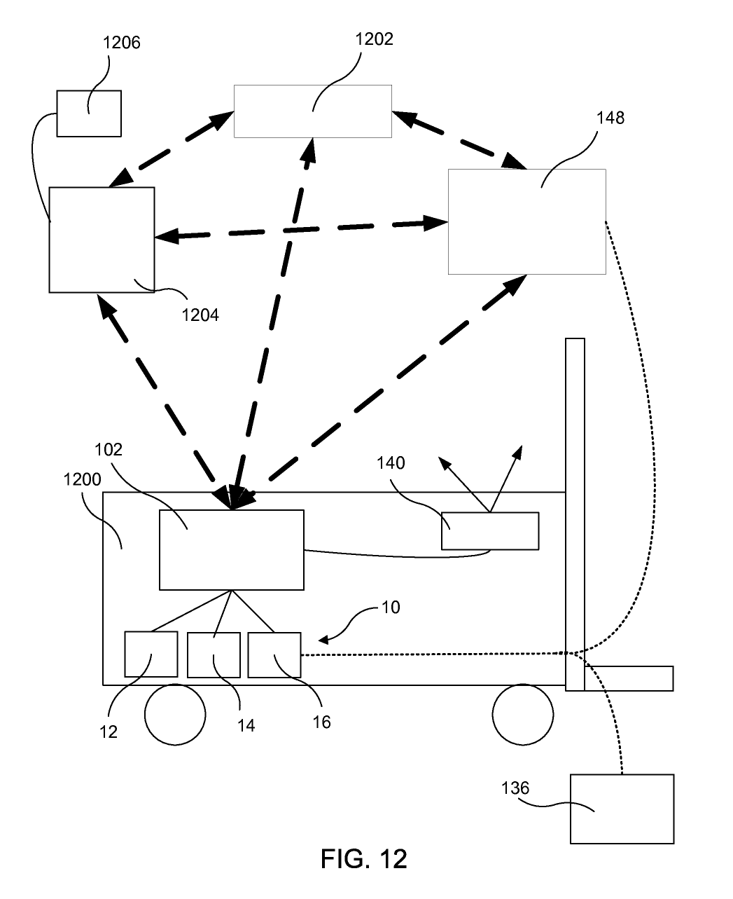

FIG. 12 is a block diagram of an example battery service system used in connection with a forklift 1200 including a battery 10. Battery 10, including cells 12, 14, 16, may be operatively connected to control module 102, which may be provided on forklift 1200 and/or may include an alarm annunciator 140. Control module 102 may be in wired and/or wireless communication (such as via a wireless receiver/hotspot 1202), with a computing device 1204, which may include a graphical user interface 1206.

In some example embodiments, an example battery servicing system may be configured to at least partially control battery charging, load testing, data importation and/or exportation, and/or battery optimization processes. In some example embodiments, charger-related parameters/controls may include one or more of turn charger on/off, voltage value turn on, voltage value turn off, charge return factor amp-hours, charge return factor percentage, charge until maximum MAC is attained, delta time, sample interval, optimization sequence, position, maximum cell electrolyte temperature, minimum impedance, and/or maximum number of cycles. In some example embodiments, load tester related parameters/controls may include one or more of maximum run time, maximum cell electrolyte temperature, minimum voltage value, impedance value, sample interval, optimization sequence, position, and/or maximum number of cycles. In some example embodiments, de-sulfator related parameters/controls may include one or more of maximum run time, impedance minimization mode, maximum cell electrolyte temperature, de-sulfate to cell voltage value, optimization sequence, position, and/or maximum number of cycles. In some example embodiments, acid adjustment module related parameters/controls may include one or more of MAC minimum value and/or MAC maximum value. In some example embodiments, control-related parameters may include cell temperature do not exceed value, cell voltage optimize value, cell voltage maximum, cell voltage minimum, amperage maximum, amperage minimum, acid adjustment module optimize value, acid adjustment minimum value, acid adjustment maximum value, and/or de-sulfation parameters.

As used herein, “optimize” and similar terms do not necessarily require actual mathematical optimization. Instead, such terms generally refer to improvements in efficiency, capacity, performance, etc. Similarly, terms such as “maximize” and “minimize” do not necessarily require actual mathematical maximization or minimization.

As used herein, battery optimization may refer to achieving and/or maintaining a relatively high electrical efficiency of the battery with respect to the operating and environmental conditions. The methods used to maintain such relatively high efficiency and the associated cell metrics used to measure that performance are subject to the interpretation and personal or professional preferences of the operator.

As used herein, device profile may refer to instructions (e.g., developed in a COMMAND Module of an example SRO system) that define certain operational and/or safety parameters associated with a controlled ancillary device. These instructions and parameters are then saved on a computer based storage system using a distinct filename for use as either a stand-alone CONTROL function, or as an element within a Battery Optimization Profile.

As used herein, battery optimization profile may refer to one or more instructions intended to control one or more devices. For example, an example battery optimization profile may include a sequence of steps performed in a repair and/or optimization process, which may include a formula driven, digital process that may be administered by a computer. Many battery repair processes may be broken down into sequential steps, such as collecting cell measurements (e.g., cell voltage, specific gravity, temperature of the electrolyte, impedance and many others). Some example embodiments according to the present disclosure may allow a battery repair technician to describe the steps taken in their repair protocol of a specific battery, or type(s) of battery(s) for the purpose of designing a series of computer controlled functions to perform similar tasks. In some example embodiments, once a successful battery optimization profile has been developed, it may be saved within the computer memory and used repetitively with scientific accuracy and repeatability.

In some example embodiments, a battery optimization profile may be used exclusively on a local SRO system or it may be exported for use elsewhere. For example, a battery optimization profile may be transmitted to other SRO systems around the world via the Internet. In some example embodiments, battery optimization profile libraries may be developed for local use or may be sold, rented, leased, franchised, or provided within an existing service network. In some example embodiments, battery optimization profiles may be developed by battery manufacturers to validate warranty claims and/or to support exclusive dealer and/or service center networks. In some example embodiments, battery optimization profiles may provide remote viewing capability for existing service centers to expand their service revenues to a world market.

In some example embodiments, battery optimization profile libraries may indentify companies or individuals that have advanced techniques, knowledge, and/or battery optimization processes that may produce superior results compared with other battery optimization profiles on the market. In some example embodiments, some battery optimization profiles may be stored in a password protected (and/or otherwise electronically protected) part of the software and/or hardware. This may allow the marketing of advanced knowledge and experience to worldwide marketplace without fear that trade secrets will be copied or compromised.

In some example embodiments, remote viewing capability and/or password protection of profile libraries may allow companies to manage battery repairs and/or optimization processes worldwide from a centralized location. For example, a remote repair company may log on to a particular battery service facility's Internet protocol (IP) address. Once logged on to that remote workstation, an individual can view and control the remote computer, and, thus, may view and control the battery repair sequences while reading cell-by-cell data in real time.

An example battery optimization profile may direct scanning of the battery during a normal charge cycle. The SRO may then analyze the collected data on a cell-by-cell basis; compare this data to the known data parameters of the specific battery and/or a database including data for like kind batteries. The SRO may compensate for local environmental conditions and/or may direct running a de-sulfation cycle until cell metrics are optimized in some or all cells, followed by a load application by a load tester to test the battery.

If the battery is not fully optimized, the SRO may direct another charge cycle, terminating the charge based upon selected cell metrics parameters. The SRO may then de-sulfate the battery again, followed by a controlled load test, followed by a cool down period, followed by another analysis of the battery's performance. This cycle could be automatically repeated as directed by the operator until the battery reaches certain parameters or simply runs through a predetermined number of optimization profile cycles. An operator may determine the battery parameters to monitor and the final acceptable performance standards to achieve, with little or no labor costs.

Some example embodiments according to the present disclosure may be configured to calculate a charger/battery electrical serviceability index. Chargers of differing design and the application of those chargers into differing battery and environmental conditions may make it difficult to determine which charger/battery combination is the most electrically efficient within a specific operational environment. Therefore, a device that collects and records various battery cell metrics may allow the operator to minimize electrical usage by matching charger/battery combinations based upon cell metrics.

For example, example embodiments according to the present disclosure may be configured to measure one or more of the following: (1) a charge return factor associated with a battery and/or (2) a charger's power factor, (3) “no battery installed” power consumption, and/or (4) power conversion efficiency. Some example embodiments may be configured to at least partially determine a battery operation's periodic equalization strategy, state of charge completion, and/or a battery's maintenance power.

As used herein, electrical serviceability index (ESI) may refer to the battery charger wattage consumed from a grid electrical source compared to the restoration of 1 amp-hour of runtime capacity to the battery. This may allow for and may be subject to the corresponding efficiency of the charger used to charge the battery. Therefore, this quantitative value may be viewed as the ESI of the battery charger and battery combination.

Substitution of the charger with a more or less efficient charger may result in an increased or decreased efficiency index. The intentional substitution of the charger compared to the same battery would be an effective method to isolate the charger efficiency values of differing types of chargers.

To measure and calculate the ESI, an example SRO system may record the AC line watts consumed by the battery charger while re-charging the battery, compared to a one-hour discharge rate of the battery during discharge at a known rate. An AC clamp meter, Hall effect sensor or other transducer may provide the AC line amperage value, while the AC line voltage may be obtained by connecting voltage probes to the charger grid source, or by simply measuring the voltage per phase with a multi-meter and entering this value in an associated spreadsheet.

Because a battery may charge and/or discharge in a non-linear manner with respect to the volts per cell (VPC) or other metrics, there will be differing ESI standards that may occur depending on how the deeply battery is discharged, the outside air temperature, the depth of discharge and other factors. Therefore, different discharge rate scenarios may apply to the specific end-user's operation of the battery, some examples of which follow.

One example procedure may be to first fully charge the battery to a state of charge value as determined by individual cell metrics. Then, the battery may be discharged for one hour (or other predetermined time period) at a constant discharge rate. Once discharged, the battery may be charged to substantially the same cell metrics based state of charge. The volts*amps or wattage consumed by the charger would be compared to 1 hour of discharge, mathematically expressed as: Volt*Amps or Watts/1 hour. The lower the V*A or watts per hour, the higher the ESI rating.

An alternative methodology may be a depth of discharge (DOD) test. An example DOD test may differ in that during the discharge cycle, the battery cells may be discharged to a specific percentage of the state of charge, such as a voltage per cell (VPC) of 1.7 volts. The VPC of 1.7 volts is considered by most industry standards as the 80% depth of discharge value of the battery. Once discharged to the desired depth of discharge, the battery may be charged to the identical cell metric based state of charge, and the volt*amps or wattage consumed by the charger may be compared to the total runtime of the battery in hours during the DOD test. This may be mathematically expressed as: Volt*Amps or Watts/Battery Runtime to DOD.

Another alternative may be to use a custom sampling bandwidth methodology, which may include sampling the time it takes to charge and discharge within a specific state of charge bandwidth range. For example, there may be a benefit to discharging the battery while beginning to record the battery runtime calculations, once the battery VPC reaches a specific value such as 2.0 VPC, for example. Once the battery VPC reaches 2.0 VPC during discharge, the runtime calculations begin and they end at another, lower VPC value such as 1.9 VPC. Upon recharging the battery, the V*A or wattage consumed during the recharging process between 1.9 and 2.0 VPC would be recorded and compared to the discharge runtime. This would be mathematically expressed as: Volt*Amps or Watts/Battery Runtime between 1.9 and 2.0 VPC.

In some example embodiments, the same test may be conducted before and after a battery optimization profile is run to determine the net effect of the optimization process with respect to ESI. The process definitions and parameters utilized in the selected battery optimization profile may be changed to “fine tune” the ESI index. The cell-by-cell based ESI may also assist in determining which cells to match within a battery, or battery-to-battery matching in a battery array. ESI may also be useful in determining the end-user's overall optimization strategy, the desired charge return factor to be employed, and/or the use or elimination of a periodic equalization strategy.

Some example embodiments may allow substantially real-time battery monitoring and/or control. For example, an SRO system may be Internet Protocol capable to allow real time remote battery viewing and control. Remote viewing and control may refer to an Internet (or other communications network) based process that allows one or more field positioned SRO systems to be monitored and controlled from any remote location with Internet access, using a centralized command and control strategy. The process may use commercially available software that provides the remote viewing of a computer desktop from one location to another. This capability may allow an individual to scan (e.g., monitor) individual battery cell metrics, develop or modify repair or optimization commands, and/or control battery repairs and/or optimization processes anywhere in the world, from one centralized location.

Some example embodiments may perform comparative evaluation process(es). For example, some example embodiments may conduct comparative analysis of individual battery cell metrics, such as comparison and/or evaluation of individual cells against a known performance standard. This diagnostics subroutine may assign a “Q Value” to individual cells and/or may be used for a variety of purposes. Some examples of Q Value applications may include one or more of the following: (1) predict the useful life remaining of a cell; (2) determine which cells or batteries should be matched to each other within a battery array; (3) determine when a cell is fully charged or discharged; (4) as a capital budgeting tool to predict when to purchase new batteries; (5) as an electrical serviceability index to evaluate the electrical efficiency of a cell and/or cell/charger combination; and/or (6) as a maintenance management tool.

Some example embodiments may include software subroutine(s) that may be configured to calculate a numerical value that can be adapted to individual battery client requirements. Cell metrics determined by the operator to have the highest importance may be more heavily weighted in the formula than those cell metrics with lesser impact on the battery's performance.

“Q Static” may refer to initial and/or historical value used as a baseline for the current Q evaluation. “Q Dynamic” may refer to the resultant cell metric change between the “Q Static” reading due to an applied load, charge, and/or other operational event. “Q Modifier” may refer to a physical, operational, calendar, and/or environmental condition that may be the basis used to modify a “Q Dynamic” rating. Example Q Modifiers may include the age of the battery, the ambient temperature the battery operates within, and/or other factors chosen by the operator.

Focus list may refer to a process of including or excluding available cell metrics from an analysis of Q Value, after which the included metrics may be assigned a weighting value based at least in part upon the operator's perception of their importance. Once the operator assigns the respective values, the software program may measure and apply the weighting to the selected metrics. The result is a quantitative Q value that may be used to compare and contrast individual cells and cell metrics.

Some example embodiments may be configured to compare the measured Q value against previous historical Q data of that specific battery cell and/or against a database of like kind cells, to determine the change of that cell. Once the Q Dynamic values can be compared between optimization sessions, trend analysis may scientifically predict the life remaining of that cell in addition to other functions.

Some example embodiments may include one or more subroutine(s) that allow the software to “learn” characteristics of one or more batteries. Some example embodiments may be configured to use Q Modifiers to adjust optimization profiles automatically. Repetitive optimization profiles run on the same serialized battery may be modified with respect to battery age, temperature and other Q Modification factors. A battery may be evaluated for changes in cell metrics based upon various applications of charging, loading, de-sulfation, and/or other processes. An example embodiment may “learn” how the battery changes with applied diagnostic processes, adapting a battery optimization profile, which may allow the example embodiment to automatically adjust various parameters to improve battery performance.

Some exemplary embodiments may include a scan module configured to monitor and/or scan the individual cells of a battery and/or a single battery within an array of batteries. In some embodiments including a graphical user interface (GUI), a scan module screen may be the “Home” screen. In some example embodiments, a scan module screen may be the first screen that appears upon successfully logging in to the system.

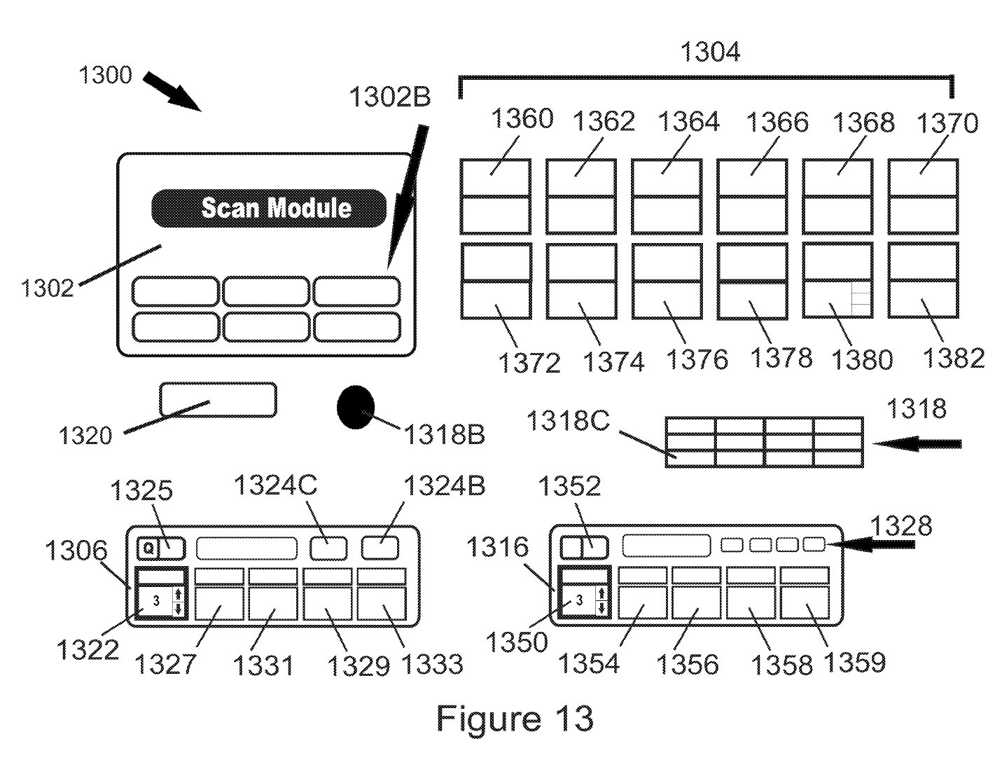

In some example embodiments, a scan module may record data from cell probes, clamps, and/or transducers and may store the data in memory. In some example embodiments, a scan module may not create functional commands or control any devices; it may simply monitor and store data. As illustrated in FIG. 13, an exemplary scan module screen 1300 may include a MODE SELECTION Panel 1302 (which may be located in the upper left corner), a QUICK VIEW PANEL 1304 (which may be located in the upper right corner), one or more CELL TRACKER modules 1306, one or more AUTO TRACKER modules 1316, and/or a WATER LEVEL indications system 1318 (which may include a warning light 1318B and/or a listing 1318C of cells with potential electrolyte level problems). Some example embodiments may also include an EMERGENCY STOP button 1320 configured to disable controlled functions in the event of an emergency.

An exemplary MODE SELECTION panel 1302 may include a plurality (e.g., six or more) colored buttons 1302B, that may allow a user to move in and out of various program modules or perform some start and/or stop functions, depending on the module or function that is in use. As an example, exiting the scan module and navigating to a CONTROL module to activate a battery optimization profile may be accomplished by selecting a control icon within the MODE SELECTION panel.

In some example embodiments, a cell tracker system may include software subroutine(s) and/or display panel(s) configured to monitor and/or display cell metrics and/or Q values. In some example embodiments, the operator may configure a cell tracker system to display data associated with particular cells that are deemed by the operator to be the most important to monitor. In some example embodiments, the displayed cell metrics may be changed to suit the operator, but an exemplary Cell Tracker 1306 may, by default, display cell identification number 1322, cell Q value 1325, cell voltage 1327, combined impedance 1329, electrolyte temperature 1331, and/or MAC 1333. An example cell tracker system may include a manual select button 1324B and/or an automatic select button 1324C. When the manual button 1324B is selected, the cell tracker may allow the operator to scroll up or down to select a specific cell for monitoring. When an individual cell tracker window is in automatic mode by selection of the automatic select button 1324C, it may interact with an AUTO TRACKER module. In some example embodiments, a cell tracker may save the operator from having to visually look through large compiled data lists to locate and track or monitor individual cells of interest, within a battery or cell array.

An exemplary cell tracker system may include both one or more CELL TRACKER modules 1306 and/or one or more AUTO TRACKER modules 1316. For example, an exemplary screen may include five cell tracker modules 1306 and/or one auto tracker module 1316.

An exemplary AUTO TRACKER module 1316 may automatically display data associated with a cell identified in cell identification window 1350 and may include optimum Q value(s) displayed in Q value window 1352 and/or other cell metric value(s) selected by the operator. An exemplary AUTO TRACKER may include more than one AUTO LINK button 1328 that may be assigned to individual cell metrics. For example, auto link buttons for voltage, temperature, impedance, and/or MAC may be provided. When one of more of these buttons is selected, the Q value subroutine may be disregarded and the selected cell metric(s) may be the basis for the auto tracker analysis. Similar to an example cell tracker module 1306, an example auto tracker module 1316 may display cell voltage 1354, combined impedance 1358, electrolyte temperature 1356, and/or MAC 1359.

Exemplary scan and/or exemplary CONTROL modules may include a quick view panel 1304, which may allow the operator to see important battery operational statistics without searching through menus or data files. In some example embodiments, depending on which mode quick view is operating under, some values and parameters may be selected or changed while the system is operating in that mode. An exemplary Quick View Panel may display or control one or more of the following:
Battery Volts 1360: Indicates the battery voltage.
Battery Amps 1362: Indicates the battery amperage during charge or discharge.
Load V Off 1364: The voltage per cell values that will turn off the load tester.
Device Run 1366: The total duration of time that the currently controlled device has been activated.
Charger Off Volt 1368: The voltage per cell value that will turn off the charger.
Charger Off MAC 1370: The MAC value that will turn off the charger.
Date and Time 1372: This is the current date and time.
Outside Temp 1374: The current ambient temperature.
Temp C or F 1376: The temperature measurement method. Click to cycle from F to C.
Temp Off 1378: The cell electrolyte temperature at which all controlled devices will be turned off.
Scan Interval 1380: Select the sampling interval of either seconds, minutes or hours followed by the numerical value.
Number of Cells 1382: This is the number of cells attached to the system that are detected.
Other operator selected metrics or functions.

In some example embodiments, a COMMAND module may be used to develop and/or save battery optimization profiles, establish password access and/or default settings, and/or define and/or save client utilities and/or battery data. Some exemplary COMMAND module screens may be activated by selecting the COMMAND button on the MODE SELECTION PANEL on any other screen.

An exemplary Command Module Window may include a MODE SELECTION Panel (which may be located in the upper left corner of the window), a client utilities icon, a battery data icon, a Batt-Test icon, a Batt-AMC icon, a Batt-Charge icon, a Batt-ReCon icon, a Batt-Smart icon, a Batt-MAX icon, and/or any other operator chosen functional icon. Example functions associated with these icons are summarized below:
Batt-Test: Defines the operational and safety parameters of any SRO compatible load tester employing a control signal.
Batt-AMC: Defines the operational and safety parameters of any SRO compatible automatic acid mixture device employing a control signal.
Batt-Charge: Defines the operational and safety parameters of any SRO compatible battery charger employing a control signal.
Batt-ReCon: Defines the operational and safety parameters for ON/OFF switching of the Batt-Recon system (e.g., a battery desulfation system).
Batt-Smart: Defines the operational and safety parameters of a battery-mounted monitoring and control system. Allows the operator to download data stored in a battery-mounted module, such as historical data, repairs, cell metrics, and other information. This module also sends programming data and commands to the Batt-Smart charge return factor programmable memory.
Batt-MAX: Allows the operator to develop battery optimization profiles by defining the sequencing and duration of operation one or more devices controlled by an SRO system.

Some example COMMAND module subroutines may create functional commands that control various external devices. These commands may be saved in a password-protected area of the program to preserve confidentiality of the profile. To create a device profile for an individual device, the operator may click on the device icon and define the operational parameters within that module. Once developed, individual device profiles may be saved with unique filenames for use as a stand-alone device profiles and/or as elements within battery optimization profiles.

An example CLIENT UTILITIES module may include a password-protected module that allows the operator to define the accessibility of the program functions and/or user preferences. An example BATTERY DATA module may include a password-protected module that allows the operator to define the battery owner's information, battery type, and/or other battery relevant information.

Some example CONTROL modules may allow the operator to select a device for a single, manually operated one-time control cycle and/or an automated battery optimization profile from a Batt-MAX profile library.

An exemplary CONTROL module screen may include a MODE SELECTION panel (which may be located in the upper left corner of the window), a QUICK VIEW PANEL (which may be located in the upper right corner of the window), a WATER LEVEL indications system, a Batt-Test icon, a Batt-AMC icon, a Batt-Charge icon, a Batt-ReCon icon, a Batt-Smart icon, a Batt Max icon, and/or any other operator chosen functional icon.

Some example SRO systems may employ a digital turn off (DTO) system that acts as an On/Off switch to control ancillary devices that utilize an On/Off signal to operate. The SRO may use an advanced digital control protocol to transmit on and/or off signals to a specially designed receiver, which may be associated with a device that the operator chooses to control from the CONTROL modules. For example, receivers may be mounted inside one or more of the controlled devices. As directed by the CONTROL modules, the receiver may connect and/or interrupt a control signal native to the device being controlled. The controlling process is thus fail safe to the default value by which the controlled device would normally operate. Similarly, a DTO system may be used to turn On/Off devices that may be controlled by an external relay.

Some example SRO systems may employ a serial peripheral interface (or an equivalent bi-directional communication interface) to control ancillary devices that utilize more than a simple On/Off control signal. Such devices may utilize a bi-directional control signal using an SPI (or equivalent) port on the master control board of the SRO to allow data to enter or exit the master control board as needed.

Once the CONTROL Module is directed by the COMMAND Module to turn on or off a DTO-capable ancillary device, or provide complex bi-directional control to an SPI-capable ancillary device, the circuitry may provide an appropriate signal to the ancillary device. For example, ancillary devices may be connected by wiring to a rear panel of the SRO System. Example ancillary devices may include battery chargers, battery load testing devices, Batt-Recon de-sulfation systems, Batt-AMC cell electrolyte automatic mixture devices, and/or any other devices that may be turned on or off by the use of an external relay system or that utilize bi-directional communications.

Some exemplary SRO systems may be configured to electronically determine specific gravity in battery electrolyte, or in other ionized solutions, using a process referred to herein as the measurement of Molecular Acid Concentration (MAC). When the process is used to measure ionization of solutions other than battery electrolyte, then the process may be referred to as measurement of Molecular Ionization Concentration (MIC).

The present disclosure contemplates that the specific gravity of battery electrolyte is the ratio of the weight of the electrolyte to the weight of an equal volume of water, compensated for temperature. As the specific gravity value increases, so does the concentration of acid in solution measured by weight. Specific gravity can then also be thought of as a non-temperature compensated Molecular Concentration measurement dependant upon the weight of a solution, rather than on an electronic molecular concentration measurement.

The present disclosure contemplates that as the number of molecules of the acid relative to water in the electrolyte increases, there may be a corresponding increase in electrolyte acid density. There may also be a positive correlation between the specific gravity and the actual molecular count (acid density) of acid in solution. Therefore, MAC may be considered a highly accurate representation of specific gravity measurements using an electronic measurement device.

The present disclosure contemplates that MAC may be based upon the chemistry principle of the ionization of solutions. The present disclosure contemplates that battery electrolyte, H₂SO₄, is an ionic solution and according to commonly accepted chemistry principles, the more dissolved ions in solution the greater the solution's acid density. Thus, MAC may be considered a method of electronically measuring molecular acid density, or the density or other ionized solutions, within that solution.

The present disclosure contemplates that MAC may be measured by, 1) sensing the electrical conductivity of the solution and compensating for temperature of the electrolyte, 2) by calculating the change in cell impedance between comparative state of charge values for the same cell or a known cell impedance baseline, compensating for temperature with other factors remaining constant, and/or 3) a combination of an impedance or electrolyte solution conductivity as a baseline factor, then correlating this baseline with the change in corresponding impedance, electrolyte solution conductivity value and temperature. The present disclosure contemplates that the MAC measurement of electrical conductivity may be generally linear with specific gravity values, and MAC measured electrical conductivity of the electrolyte may 1) be electronic and highly accurate, 2) require little if any human labor factors, and 3) compensate for temperature of the electrolyte during measurement. Thus, unlike specific gravity measurement methodologies, MAC may be able to deliver highly accurate, high-resolution data streams in real time to a computer based control system. Battery optimization using MAC compared to specific gravity may be more efficient and cost effective than manual specific gravity methodologies.

In some example embodiments, the molecular acid concentration of a battery cell may be determined by measuring the impedance of the battery cell, measuring a temperature (e.g., ambient temperature and/or electrolyte temperature), and using a known relationship between the measured impedance and the measured temperature. In some example embodiments, the known relationship may be determined in advance using one or more test batteries that may be substantially similar to operational batteries. In some example embodiments, impedance may be measured using clamps operatively connected to the plates of the battery cell. Thus, in the case of sealed batteries, for example, a representative sample of the batteries may be evaluated to determine the relationship between impedance and temperature to avoid the need to access the electrolyte of all operational batteries.

An exemplary SRO system's MAC based methodology of measuring molecules of acid may be used to measure sulfation accumulation on the internal lead plates of the battery. If a battery is new and the internal lead plates are free of sulfation, then the MAC value or coefficient would indicate a high molecular density of acid molecules upon a given state of charge, or upon the same state of applied charge by a battery charger. As the battery cycles and ages, sulfates are accumulated onto the internal lead plates reducing the ions of acid molecules within the electrolyte solution. The diminished concentration of acid molecules may be indicated by lowered MAC values upon the same applied state of charge to the electrolyte.

Notwithstanding the external loss or addition of acid molecules during operation of the battery, or variables caused by electrolyte stratification, the MAC values may remain substantially constant if the lead plates are free of sulfates. A MAC value that diminishes over time, all other factors remaining substantially constant, may indicate the corresponding and generally linear accumulation of sulfates onto the plates of the battery. Therefore, the precise nature of a MAC value delta compared to the historical and operational database of the specific battery may be an accurate predictor of sulfation accumulation.

An exemplary SRO system's MAC based methodology of measuring molecules of acid may be used in conjunction with other measurement elements as a predictor of the capacity of a lead-acid battery. As the battery discharges at a constant rate, the specific gravity and MAC values may decrease in a generally linear manner. As the battery charges at a constant rate, the specific gravity and MAC values may increase in a generally linear manner. When MAC values are compared to other cell metrics, then a scientific formula may be developed to electronically determine battery capacity.

With respect to MAC, an exemplary SRO system may provide a known signal into the solution via more than one electrically isolated electrolyte probes, or a single probe with more than one electrically isolated conductive elements, and may measure the return portion of the signal to determine the conductivity of the solution. The higher the MAC score, the higher the molecular level of acid concentration. The lower the MAC score, the lower the molecular level of acid concentration. Since the probe may be in contact with the electrolyte for MAC measurements, MAC may be most useful for batteries with readily accessible electrolyte solutions. Batteries with inaccessible battery electrolyte, jellified or absorbed mat electrolyte, may use temperature compensated impedance measured at the battery cell terminals as an alternative method of calculating MAC.

The present disclosure contemplates that a battery testing technique that involves measuring the impedance/conductance of storage batteries may involve the use of Kelvin connections. A typical Kelvin connection is a four-point connection technique using an electrically isolated clamp to physically and electrically connect a measuring device to a battery or battery cell terminals. The electrically isolated Kelvin clamps apply a known current, voltage and frequency into a battery through two pairs of clamps, one pair located on battery terminal contact, while a second pair of Kelvin clamps are attached to the opposing battery terminal contact. The applied force signal is introduced into the battery using one half of each Kelvin clamp, while the other half of each respective clamp receives the sense signal, once the force signal is passed through the battery

The present disclosure contemplates that various types, sizes and shapes of physical clamps have been designed to connect to the battery's terminals, which provide the electrical connections for the Kelvin connection circuit. However, the scientific performance of these clamps may be limited by the quality and design of the clamp, the quality and electrical consistency of the actual contact mating surface area between the clamp and the battery terminal, and/or the quality of the battery or battery cell terminal. Thus, the present disclosure contemplates that the traditional Kelvin clamp design may be limited in scientific accuracy and may have physical limitations that prevent universal application to flooded electrolyte battery types typically found in industrial battery applications.

As illustrated in FIG. 6, an example liquid medium connection (LMC) apparatus may provide a 3 or 4 point “Kelvin connection” comprising two or more electrically conductive probes 200A, 200B, or a single probe including more than one electrode, dipped into the electrolyte of at least two individual (typically adjacent) series connected batteries or battery cells 12, 14, providing a Kelvin connection using the electrolyte solution to probe tip contact area as a connection medium. Each probe comprises at least two electrically conductive, isolated electrodes 218A, 220A, 218B, 220B to allow measurement of battery or battery cell impedance/conductance, absent of mechanical clamps typically used in a Kelvin connection devices. Thus, LMC technology may eliminate potential errors caused by the mating contact area between the conventional Kelvin clamp and the battery terminal connection. LMC technology may also allow the universal application of the conductive probe requiring only access to the electrolyte.

Impedance/conductance measuring from the electrolyte to the positive terminal post may provide an advanced measuring methodology allowing the impedance of the positive plates of the cell to be isolated and analyzed. Impedance/conductance measurements from the electrolyte to the negative terminal post may isolate the negative plate impedance of the cell. For example, these measurements may be conducted using one electrolyte probe in conjunction with a terminal post clamp attached to the respective positive or negative post, for example.

The present disclosure contemplates that a variation of the four point design is a three point design, wherein separate force and sense leads may be in one battery or cell electrolyte solution, while the remaining contact referred to as the “common” point is located in an adjacent battery or battery cell. The three-point design may be useful, for example, when measuring the battery or battery cell impedance/conductance of a battery or battery cell located in the “end-of-the line” position in a battery array, or a series positioned group of individual battery cells. A variation of the “end-of-the-line” methodology may use one mechanical two-conductor clamp or probe, in combination with one LMC probe, to measure battery or battery cell impedance/conductance when only one cell has an exposed or accessible electrolyte fluid medium.

An exemplary LMC measurement protocol may be accomplished in a sequential manner with respect to adjacent batteries or battery cells using the electrolyte contained within adjacent battery cells or cells as the conductive medium, thus replacing the physical clamp connections typically utilized in other Kelvin clamp methodologies.

An exemplary SRO system may control ancillary devices in a manner that provides for the automated optimization of a battery. This may be accomplished, for example, by scanning the battery's historical operational characteristics, followed by testing and/or data collection methodologies that may allow the comparison of the measured performance parameters within a localized or global battery database. Once the comparison is completed, the SRO command module may determine a series of corrective actions that are to be applied to the battery. The SRO control module may then control the corrective actions in the proper sequence, by switching on and off various ancillary devices for measured intervals and/or to accomplish desired functions. Once the pre-determined cycle of actions is complete, SRO device may then scan the battery operational characteristics and 1) determine that the battery is in an optimized condition at which time the optimization cycle is terminated and/or 2) determine that additional applications of one or more of the ancillary devices may be required. This cycle (or components of this cycle) may continue until the battery performance metrics fail to improve or the manual override system cycles or times out. Upon completion of the optimization process, the SRO system may assign a Q Dynamic value to the cell for diagnostic and historical purposes. Once the Q Dynamic value is stored in the historical log it is then considered the current Q Static value.

This disclosure includes exemplary SRO methodologies that may determine and/or control an individual battery's operational charge return factor requirement. The charge return factor may be defined as the number of amp hours returned to the battery during the charge cycle divided by the number of amp hours delivered by the battery during discharge. This measurement may be accomplished by providing an external (e.g., battery-mounted) device configured to measure the individual battery's event based, amp-hours charge and discharge rate. The external battery mounted device may then communicate to an external battery charger mounted device and control the battery charger's completion parameters based upon the desired charge return factor. Cell or environmental metrics monitored by the SRO system, or Q values may be used to further modify the charge return factor algorithm.

Utilizing charge return factor charge completion control may result in an increase in electrical efficiency, with a reduction in battery electrolyte gassing caused by overcharging. The reduction of battery gassing may reduce the internal corrosion to the battery plates, thus potentially extending the life of the battery.

The SRO system may also allow the battery operator to reduce or eliminate the periodic overcharging referred to as the periodic equalization strategy, saving electricity and reducing harmful overcharging.

An exemplary SRO System may be configured to control ancillary devices based at least in part upon cell or environmental metrics, or Q values.

An exemplary SRO System may include permanent and/or semi-permanent storage of historical, operational, and/or maintenance activities for an individual cell or battery. Some exemplary methods may create a permanent data “logbook” of user input as a record keeping process that follows the battery during its operational lifetime. This may allow the operator to input data, remarks, and/or notes concerning the battery's historical life or Q value storage using commercially available software formats.

An exemplary SRO System may collect the raw data elements, which may be used to determine the battery operation's charge completion analysis protocol.

An exemplary SRO System may interface the battery cell metrics into a data protocol referred to as remote viewing, allowing the transfer using the internet and a website based portal. Remote viewing and control may allow an operator to monitor and/or control a battery SRO process from anywhere in the world, providing that the SRO system has an Internet portal. This web-based portal may be used to develop a worldwide database that may provide statistical analysis of battery/charger combinations and resultant battery/cell efficiency ratings.

An exemplary SRO System may develop and/or store battery specific cell metrics or Q values into a local database, allowing the transfer using a local intranet, the Internet, and/or a website based portal, and/or simply transferring data via any conventional telecommunications or computer data transferring means such as an RS 232 communication protocol.

An exemplary SRO system may use cell metrics or Q values to alter the native battery charger or other device operational profile, with respect to each specific battery's operational history. This may be accomplished by providing an internal or external battery mounted device to measure the specific battery's event based cell metrics and communicating those metrics to the charger or device control module.

An exemplary SRO System may determine when the battery has accumulated undesirable levels of sulfation requiring that sulfation elimination techniques be employed. This may be accomplished by providing an external (e.g., battery-mounted) device configured to measure and communicate the specific battery's event based, cell metrics data.

An exemplary SRO System may be configured to reduce the risk of the phenomenon of thermal runaway during the charging of the battery (and/or during operation of other ancillary devices). This may be accomplished by providing an external (e.g., battery-mounted) device configured to measure and communicate the specific battery's event based, cell metrics data.

FIG. 1 illustrates an exemplary SRO system. Such a system may be configured to monitor the charge return factor of a specific battery using a battery mounted device that reads and calculates the amp-hours removed from the battery during dis-charge, stores those amp-hours as a quantitative value in a memory register, compares that value against the re-charging restorative amp-hour quantitative values, processes that comparison, and/or provides a control signal to a separate charger or ancillary device control module. Such a control signal may allow or interrupt the charger or other ancillary device native operational profiles.

Referring to FIG. 1, an exemplary SRO system may read and calculate cell metrics and Q values during dis-charge, re-charge, or other events and store those metrics or Q values in a memory register, compare those values against the previously established metrics and Q value optimal ranges, process that comparison and provide a control signal to a separate charger control module that interrupts the charger (or ancillary device) operation in the event that one or more cell parameters is exceeded.

Some exemplary SRO functional modules may operate within a basic “Master/Slave” configuration. The Master Module may be provided within an SRO facilities system and/or a battery-mounted system such as the Batt-Smart module. An example facilities based system may be designed to be stationary, while an exemplary battery-mounted master module may be used as an independent, mobile battery monitoring apparatus. A stationary or mobile slave controlled module may be mounted externally or internally to an ancillary device.

In some exemplary embodiments, the master module (e.g., battery-mounted and/or facility-mounted) device may be directed by the SRO to create a control signal that may be transmitted to the slave module. The master module may also receive data transmissions from one or more slave modules that are then provided to the SRO software system. A master module may include, 1) a printed circuit board, 2) a Hall effect sensor or equivalent amperage sensing device, 3) a transducer adapted for measuring required raw data, 4) a digital and/or analog processing circuit, 5) an alarm warning mechanism, 6) a volatile and/or a non volatile memory circuit, 7) a wired or wireless communications interface for bi-directional computer data transfer, 8) a signal generation/receiving circuit capable of transmitting or receiving control or data signals to and from the slave modules, such as via either a wireless link, a separate externally wired communications channel, and/or as a frequency modulated link over the existing battery charger to battery connection cables.

Example SRO slave modules may be controlled through the master module using the command-control functions of the SRO software systems. Example slave modules may replace and/or modify an ancillary device's native control functions, as directed by the SRO software through the master control module. Example slave modules may be used for monitoring, storage, processing, computer data input/output, localized alarm generating and/or receiving and/or transmitting bi-directional signals, and/or used for the storage and re-transmission of data not related to control of that specific slaved device.

An exemplary slave control module may include 1) a printed circuit board, 2) one or more Hall effect sensor or equivalent amperage sensing devices for AC or DC amperages, 3) a transducer adapted for measuring required raw data, 4) a digital and/or analog processing circuit, 5) an alarm warning mechanism, 6) a volatile and/or a non volatile memory circuit, 7) a wired or wireless communications interface for bi-directional computer data transfer, 8) a signal generation/receiving circuit capable of transmitting or receiving control or data signals to and from the battery mounted or facilities device, or other devices, via either a wireless link, a separate externally wired communications channel, and/or as a frequency modulated link over the existing battery connection cables, and/or 9) a control device configured to provide ancillary and/or primary control to the ancillary device.

Referring to FIG. 3, Batt-Charge may include an independent slave module mounted within or adjacent to a battery charger, that may be configured to control that battery charger using the SRO functions.

Referring to FIG. 3, an exemplary Batt-Charge System may receive a data stream or signal from the facilities or battery-mounted device that provides a signal to control a charger or other ancillary system, using a charger or ancillary system mounted device to start and stop operation of said device, based upon the presence or absence and differentiating signal characteristics of a control signal provided by the battery mounted or facilities monitoring device. The battery mounted (Batt-Smart) monitoring device may be mounted, for example, on an individual battery or an individual vehicle, station, or platform from which the battery operates, to provide an ongoing historical record of battery charged, discharged, and/or other operational events.

In some exemplary embodiments, a Batt-Charge system may allow a native battery charger and/or ancillary device to operate unaffected, until a signal or data stream is received by the Batt-Charge slave module to interrupt or modify the charger or ancillary device's operation. Once this command is received, Batt-Charge may perform the commanded function, modify the charger or ancillary device operating profile until control is again commanded by the SRO control system, or other control releasing qualifying events occur that may be preprogrammed into the slave module.

An example of a slave device qualified termination of control event may be that the battery is disconnected from the charger, which would drop the connection voltage indicating that the battery was no longer connected to the charger. In this event, Batt-Charge may reset to the charger default control system until another battery is connected to the charger, in which case the Batt-Charge system may be reset to monitor a control signal sent from the SRO system. In the event that a control signal is received from a SRO system, Batt-Charge may take control of the charger and disable or modify the charger's native charge profile.

Referring to FIG. 7, an exemplary Batt-Test may include an independent slave module mounted within or adjacent to a battery-discharging device. Batt-Test may replace or modify an existing battery discharge load testing device's native control functions. The Batt-Test slave module may have substantially similar construction and operation as the Batt-Charge slave module, except that it may be operatively connected to a load-testing device instead of a charger, for example.

Referring to FIG. 7, an exemplary Batt-Control may include an independent slave module mounted within or adjacent to a battery ancillary device. Batt-Control may be configured to control that battery ancillary device using the Scan-Command-Control functions of the SRO software systems. Batt-Ultra Control may replace or modify an existing battery ancillary device's native control functions. The Batt-Ultra-Control slave module may have substantially identical construction and operation as the Batt-Charge slave module, except that it may be operatively connected to a battery ancillary device. Example battery ancillary devices may include a float charging device, a device that monitors and isolates the battery's discharge rate when not in use, a device that may isolate a battery from a vehicle, platform or stationary location from which it operates, a device that activates an alarm or safety device in case of fire in or near the battery.

Referring to FIG. 3, an exemplary Batt-Smart may include an independent battery mounted master control module that may control one or more functional modules, typically a battery charger or ancillary device, using the Scan-Command-Control functions of the SRO hardware and software systems. The Batt-Smart system may collect, store and/or process the operational history of the specific battery it is attached to, providing a discrete Scan-Command-Control function from that specific battery. Batt-Smart may also provide command and control functions for ancillary control modules.

In some exemplary embodiments, Batt-Smart may also monitor individual cell metrics or Q values using individual or multiple cell electrolyte probes, terminal clamps, sensors or transducers, individual or multiple cell or battery surface probes, or any combination therein, for example. There may also be an amperage-sensing device to enable the system to calculate the amp-hours passing through the battery during charge or discharge cycles.

Referring to FIG. 3, an exemplary Batt-Smart system may monitor the specific battery using a battery mounted device that provides a signal to control a charger or other ancillary system, using a charger or ancillary system mounted device to start and stop operation of said device, based upon the presence or absence and differentiating signal characteristics of a control signal provided by the Batt-Smart monitoring device. The battery mounted monitoring device may, for example, be mounted on each unique and specific battery providing an ongoing historical record of all battery charge and discharge or other operational events.

In some exemplary embodiments, when Batt-Smart is used in conjunction with an existing charger or ancillary device that has a native control system, then Batt-Smart may be used as a secondary control and limiting device while the battery charger or other ancillary system device maintains primary control during normal operation. In the event that Batt-Smart determines that a pre-determined, cell or battery based metric control parameter has been exceeded, then Batt-Smart may create a signal that is transmitted to the charger or ancillary control device interrupting the device's operation, thus providing a secondary control.

An exemplary system may be comprised of 1) an externally mounted Batt-Smart master module, and 2) a functional module or other ancillary device controller The battery-mounted master module may be used as a monitoring device, provide data storage functions, function as a command generator, function as a control generator, provide processing functionality, accommodate computer data input/output, provide a localized alarm generating device and/or function as a signal receiving/transmitting device. The functional module may be used as a monitoring, storage, processing, computer data input/output, localized alarm generating device and/or signal receiving/transmitting device, with a functional connection to control the device to which it is attached.

An exemplary battery mounted monitoring device may be mounted on an individual battery, the monitoring of which may provide an ongoing historical record of all battery charge and discharge and/or other operational events. In some exemplary embodiments, the Batt-Smart battery-mounted device may provide the primary command and control device, while the functional module may provide limited or no command and control capabilities.

An exemplary Batt-Smart control system may be connected to one or more standard conductive electrical probe(s), battery terminal clamps or other sensors or transducers, that may be mounted within or onto a single cell, or multiple cells. The probes or transducers may gather the raw data that may be processed by the Batt-Smart module, which may then provide for the command and control device to control the functional modules as determined by the imbedded software parameters within the Batt-Smart memory module.

Referring to FIG. 8, an exemplary Batt-AMC may comprise a slave device that adjusts the battery cell electrolyte's Molecular Acid Concentration (MAC) using the Scan-Command-Control functions of the SRO hardware/software systems. An exemplary Batt-AMC may permit removal and/or addition of electrolyte, or any fluid, into or out of an individual battery cell, when controlled by either the facilities based or battery based SRO modules, or an optional stand-alone Batt-AMC master control module, all of which may be integrated with SRO systems. The Batt-AMC subroutines controlled by SRO systems may include basic operations such as 1) a fluid removal process, 2) a fluid restoration or filling process, and/or 3) an acidity testing, comparison, and/or analysis process.

An exemplary SRO system may include an acid adjustment software subroutine in which the adjustment of the acid concentration may be Scanned-Commanded and Controlled automatically. In an exemplary mode, a SRO device may first charge the battery and scan the cells individually. Molecular Acid Concentration (MAC) values may be monitored and recorded, then compared to an operator selected value, or a local or global database. Once the SRO system has completed the optimization processes, with respect to acid adjustment indicated by the maximization of MAC, then the final MAC value will be compared to the operator selection or resident databases.

In an exemplary embodiment, in the event that the MAC value is below the desired value, then the SRO device, or the optional Batt-AMC Master Control Module, may instruct the optional Batt-AMC module to remove cell electrolyte, then add electrolyte and re-charge the battery. Once the re-charging cycle is complete, then the SRO device may again re-test the MAC values and either: 1) terminate the subroutine because the MAC values fall within acceptable guidelines, or 2) conduct another Batt-AMC process to the affected cell. The process of testing, comparing, commanding and controlling the Batt-AMC system may continue until the MAC values are within an acceptable range or the system times out from a predetermined cycle counting process.

An exemplary Batt-AMC may include basic devices, such as 1) an acid and/or fluid storage, pumping, and metering mechanism, 2) a special electrolyte probe, 3) a slave control module, and/or 4) an optional master control module to allow Batt-AMC to operate independently of the facilities or Batt-Smart SRO Systems. The Batt-AMC slave control module may include a modified Batt-Charge slave module adapted to the operation of the Batt-AMC system. The optional Batt-AMC Master Control Module may include a simplified version of the SRO facilities system, with an integral computerized system and a modified SRO software program dedicated to Batt-AMC.

In an exemplary embodiment, the storage device may include acid proof reservoir tank(s), which may be located near the battery to be acid adjusted. The pumping device may include a commercially available acid proof suction or pressure device that will remove lower density acid electrolyte from the battery cell, followed by injection or gravity replacement of a higher density acid electrolyte (or other fluids) into the battery cell. The transfer of acid (fluids) are facilitated to and from the battery cell using, for example, a hollow pipette that is either a freestanding device, or an integral part of the special electrolyte probe used in the SRO System. The hollow pipette may be connected to the pump, metering mechanism(s) and reservoir(s) using rigid and/or flexible tubing. Acid proof metering valves may be used to provide an open pathway for the flow of fluids either into or out of the battery cell. The valves may be controlled electrically, pneumatically, magnetically and/or using vacuum, for example.

As an alternative to a pump and metering valve combination, a single peristaltic pump with acid proof tubing, may be used without the use of individual metering valves, thus eliminating or reducing potential valve failures. See, e.g., FIG. 9. In this application, two peristaltic type pumps may be dedicated to each cell position, one for the removal of fluid and the other for the re-filling of fluid. The interconnecting tubing may have an acid proof check valve to prevent fluid movement without the associated pump creating pressure or suction. The control signals from the SRO device may be simplified to on/off signals directed to the respective fill or removal pump for each cell position, eliminating individual cell metering valves. A “Y” shaped coupling tube in combination with one way check valves, may be used between the two peristaltic pumps and the individual cell probe, to allow both opposing pumps to access the single electrolyte probe.

During the removal cycle, the “removal peristaltic pump” may be commanded to operate, which may draw fluid from the cell and deposit directly in to the waste tank. During the fill cycle the corresponding “fill peristaltic pump” may be commanded to operate, which may draw fluid from the new fluid storage tank and pump it directly into the battery cell.

As an alternative to a pump and metering valve combination, a gravity feed and/or vacuum system may be used. A gravity feed system may utilize a valve that would be opened to allow a new solution tank located above the battery cell, to fill the battery cell with fluid via gravity, and closed by the SRO device when the fluid level was at the prescribed level. A vacuum system may be used during the removal cycle to “siphon” or vacuum assist fluid removal from the battery cell. Either process may be controlled by SRO systems and minimize or eliminate potential valve failures.

In some exemplary embodiments, once the SRO System determines to modify the acidity of the battery cell, a Batt-AMC removal cycle subroutine is begun. An exemplary Batt-AMC removal cycle may include an “Open” control signal being sent to: 1) the metering device to open the valve between the pump and the waste fluid storage tank, and/or 2) a cell control valve connecting the pump and respective cell to be treated. Once the valves are in the correct position, an activation signal may be sent by the SRO device to the pumping mechanism to remove fluid from the specific cell identified by the SRO device, to the waste storage tank.

In some exemplary embodiments, a measurement device may be used to determine the volume of fluid to be removed from the cell, and upon successful removal of the desired volume (or a system time out), the SRO device may terminate the removal cycle. Once the pump removes the prescribed amount of fluid from the cell and completes the fluid removal cycle, the SRO device may then close the cell metering control valve, close the reservoir control valve and/or turns off the removal pumping mechanism.

An exemplary Batt-AMC fill cycle may include an “Open” control signal being sent to: 1) the metering device to open the valve between the pump and the new solution fluid storage tank, and/or 2) a cell control valve connecting the pump and respective cell to be treated. Once the valves are in the correct position, an activation signal may be sent by the SRO device to the pumping mechanism to fill fluid into the specific cell identified by the SRO device, from the new solution storage tank.

In some exemplary embodiments, a measurement device may be used to determine the volume of fluid that is restored to the cell, and upon successful filling of the desired volume (or a system time out), the SRO device may terminate the fill cycle. The SRO device may use the electrolyte level monitoring capabilities found in the SRO probe assembly to monitor the level of acid or fluid injection into the battery cell. In the absence of a probe shutoff value or a fault code from SRO probe monitoring subroutine, the Batt-AMC subroutine may time out to prevent over-filling of the system. Once the pump fills the prescribed amount of fluid into the cell and completes the fluid filling (restoration) cycle, the SRO device may then close the cell metering control valve, closes the new solution reservoir control valve and turns off the pumping mechanism.

In some exemplary embodiments, once the Batt-AMC system removes and adds acid concentrations, the new mixture may be cycled though another charge cycle by the SRO Command and Control device, or charged by a conventional charger, or simply placed back into service without additional charging. It may be advantageous to operate Batt-AMC after battery optimization techniques have been implemented to prevent a higher concentration of acid than was intended by the battery manufacturer. It may also be advantageous to conduct another charge cycle followed by a scan and comparison process to determine if the desired acid concentration has been achieved.

Batt-Scan

Referring to FIG. 10, an exemplary Batt-Scan may include an independent scanning device, which may be hand-held and which may rapidly test and compare an individual motive industrial battery, or equivalent, battery cell against the known Q value or other cell metric database standard of that specific battery's historical operational characteristics local database, or a battery cell database collected from global resources, or develops data samples from the immediate testing of the battery or cells using the Batt-Scan device. This device may use an RFID identification device that identifies each specific battery or battery cell. This device may also collect, process and/or store the data by interrogating a smart probe, an SRO facilities system, a Batt-Smart system, or other equivalent devices.

An exemplary Batt-Scan device may include a handheld and/or portable system that allows a technician to easily field test the battery or individual battery cells using similar hardware and/or software systems as may be found in the facilities or battery based SRO system, but in a portable/hand-held version. The Batt-Scan system may then be referred to as a “hand-held,” SRO system, which has some or all of the SRO operational characteristics.

An exemplary Batt-Scan system may include an electronic circuit board, a digital processor, an input and output device, special probes, clamps, or transducers, and/or a resident software program. Batt-Scan may use the historical operational database collected, stored and processed by a smart probe, as a standalone data source using probes or other devices built within or attached to the Batt-Scan device, or in conjunction with additional data inputs produced using other external devices.

Referring to FIG. 3, an exemplary battery charger 300 may include an independent slave battery-charging device (which may not include a native control device) configured to re-charge a battery. The control device may be provided by the Scan-Command-Control functions of the SRO hardware and software systems. The SRO Batt-Smart battery mounted device or the SRO facilities system may control the universal charger.

In some exemplary embodiments, the SRO facilities system or Batt-Smart battery mounted system may be used as the primary control mechanism for a “Universal” charger design. Such a design may eliminate the need for each charger to have a self-contained command and control processing system with pre-determined charge profiles. The slave charging module may be controlled by the master module providing constant or variable voltage output, constant or variable amperage output, variable frequency output, or provide other advanced control features.

An exemplary universal charger may provide output-charging power to a battery, as commanded and controlled by the SRO system. Thus, an exemplary battery charger 300 mechanism may include the raw elements and mechanical parts necessary to provide output power to the battery. These parts may include a ferroresonant transformer charging mechanism, a silicone controlled rectifier charging mechanism, an insulated gate bi-directional transistor controlled system, or a frequency generated or pulse width modulated mechanism, or other battery charging mechanism.

In some exemplary embodiments, an individual smart battery module equipped battery may substantially completely control the universal charging device, thereby allowing use of a universal charging device without its own control mechanisms within the charger. For example, on one occasion, a 24-volt, 600 amp-hour battery may be connected for re-charging, that has been working in an environment of 30 degrees F., requiring a different charge profile than the next battery, which may be a 36-volt, 750 amp-hour battery operating in a hot warehousing environment. In both cases, the battery charge profile may be determined by and residing in whole or in part within the smart battery module mounted on the battery, with command and control functions being determined by the battery module that may then control the universal charger.

Some exemplary SRO Systems may have the broad, pre-determined charge profile instructions for a specific battery type, which may be modified by the operational environment metrics in which the particular battery operates. With independent and unique control parameters, each battery may have the optimum charging profile adapted for individual charge cycles.

Referring to FIG. 2, an exemplary SRO conductivity probe may provide accurate measurement of individual battery cell metrics that include but are not limited to voltage, temperature, impedance/conductance, electrolyte fluid level, and MAC. The SRO probe may include two or more electrically isolated, discrete electrodes contacting the electrolyte solution when the probe is inserted into an individual cell of a battery. A third probe element may be incorporated to allow the automation of electrolyte acid adjustment.

In some exemplary embodiments, the SRO system may be configured to ascertain and/or account for a plurality of probes being installed into individual cells of a multi-cell battery in a random order. An exemplary SRO system may read the individual probe voltage levels, and/or other cell metrics, to determine which probe is in which cell. Then, the SRO system may assign the probe positions according to an ascending voltage or other cell metrics. Thus, the SRO device may not be limited to a predetermined placement of the probes in indexed positions in the battery cells or battery array.

FIG. 2 illustrates an exemplary probe according to the present disclosure. The standard electrolyte probe is designed to actually contact the electrolyte solution in the cell. The probe may include an electrolyte resistant shaft that is dipped into the electrolyte through a preexisting cell opening, by a drilled hole into the vent cap, by a probe integrated replacement vent cap design, or a drilled hole into the case of the battery.

An exemplary probe may measure voltage from the electrolyte referenced to battery ground or other battery point, and may send it directly to a monitoring module as the Cell Voltage V1.

Cell voltage measuring from the electrolyte to the positive terminal post (VP) may allow the voltage of the positive plates of the cell to be isolated and analyzed. Voltage measurements from the electrolyte to the negative terminal post (VN) may isolate the negative plate voltage. Both of these measurements may utilize one electrolyte probe in conjunction with a terminal post clamp attached to the respective positive or negative post.

An exemplary probe may include a thermistor, resistive temperature device, or other thermally affected component, mounted in a thermally conductive manner and electrically connected to the probe. The other end of the thermal component may be connected by wire to the SRO monitoring module. As the electrolyte temperature changes, the measured cell voltage is modified by the varying resistance and sent to the SRO monitoring module as a temperature value, the Cell Temperature T1.

In some exemplary embodiments, a probe may measure the level of the electrolyte by sensing voltage at the probe tip. In the absence of electrolyte contacting the probe, there will be an absence of voltage signal at the probe. The presence or absence of voltage at the probe may indicate whether the electrolyte level is above or below the tip of the probe. As an alternative, the probe tip element may be located at the appropriate electrolyte fluid level required, thus providing a calibrated measurement device.

In some exemplary embodiments, a probe may measure the level of the electrolyte fluid by using a separate level conductive probe element inserted into a standard probe. The amount of surface area of the probe that is in contact with the fluid electrolyte may provide a variable electronic measurement value when used in conjunction with a fluid level measuring methodology. The higher the fluid level, the greater the area of the conductive surface contacting the electrolyte, resulting in an increased measured electrolyte level.

In some exemplary embodiments, a separate probe element may be located at a position within the standard probe housing, where the electrolyte fluid level may only allow voltage measurement at that specific measured fluid level.

In some exemplary embodiments, a probe may measure the Molecular Acid Concentration (MAC) value of the electrolyte by resistance or conductance between the tips of two or more isolated conductor probe elements. As discussed above, an increasing MAC value represents a corresponding increase of acid molecules in solution, while a decreasing MAC value represents a reduction in acid molecules in solution.

In some exemplary embodiments, a probe may measure the Impedance/Conductance (CI) value of the electrolyte by resistance or conductance between the tips of two or more isolated conductor probe elements, which may be placed in the electrolyte of at least two adjacent cells known as the primary cells, within a cell array of more than one cell. The resultant impedance value may be measured between the electrolyte of one cell and the other cell, including the impedance of any cells that may be placed between the primary cells.

Cell impedance measuring from the electrolyte to the positive terminal post (CI-P) may provide an advanced measuring methodology allowing the impedance of the positive plates of the cell to be isolated and analyzed. Impedance measurements from the electrolyte to the negative terminal post (VI-N) may isolate the negative plates impedance. Both of these measurements may utilize one, two or more conductor, electrolyte probe be used in conjunction with a Kelvin type of terminal post clamp attached to the respective positive or negative post.

In some exemplary embodiments, a probe may provide a hollow pipette, drilled passageway, or similar device, to remove electrolyte from the cell for external storage or disposal, add electrolyte to the cell from an external reservoir, or add water or other solutions from an external reservoir to allow an automated mechanism to adjust the acidity (MAC value) of the electrolyte. The addition of acid, water or other solutions, could thus be automated and/or controlled by the SRO device, or other device, to provide the proper MAC value to the electrolyte.

Referring to FIG. 11, an exemplary smart probe may be generally similar to a standard conductive electrolyte probe passive design, except that it may include an “active” design for storing data readings on an imbedded circuitry within the probe for later transmission to an external reading device. The external reading device may be a SRO facilities system, a Batt-Scan monitor, or other external ancillary devices. An exemplary smart probe may have substantially similar cell metric capabilities as a standard electrolyte probe. An exemplary smart probe may also include additional clamps, transducers, or other sensing devices that provide additional raw data input sources.

An exemplary smart probe may include similar electronic circuitry and electronics as the Batt-Smart master control module, but it may be provided in a separate and/or stand alone device. An active probe may include an embedded firmware program to monitor and/or store the cell data parameters.

In some exemplary embodiments, a computer and/or separate external monitoring device may read the smart probe, like the Batt-Smart master control module, by either a wired or wireless connection. Exemplary wired connections include, but are not limited to, a CAT 5 Ethernet cable, a USB cable, or FM or other radio signal transmission over the charger cables, ultimately read and monitored by a computer and/or a module within the charger/de-sulfator. Exemplary wireless connections include but are not limited to, a Wi-Fi, Bluetooth or other wireless connection. The wireless system may be capable of transmitting a condition status to a localized “hotspot” or receiver, either upon a monitored malfunction event, or on a periodic basis, for example. While the system is designed to be utilized on a motive type of battery, with accessible individual cells, it is understood that the device will also work equally well on battery systems that use individual batteries combined together as a battery pack, regardless of the voltage array, or simply on an individual battery.

An exemplary SRO master control module monitoring device may be mounted on a motive battery, or an individual vehicle, station, or platform from which the battery operates, or near individual batteries of a multi-battery array, and/or may collect raw data or cell metrics from individual probes, modules, and/or other transducers and sensors.

An exemplary Master Control Module may also contain a dedicated, non-volatile-permanent memory module that may be used to store various data, such as a Carbon Tracker (Watts), Historical, Operational, Vibration and/or user defined information Data requiring permanent (or semi-permanent) data storage, in a separate module. The device may include an alarm system that actuates an annunciator (which may be mounted on or near the battery, vehicle, platform or station), when any of the critical battery cell operational parameters have been exceeded, notifying the operator that the battery cell requires inspection. The device may also include a RFID or “pinger” to identify the battery to the SRO facilities system, and/or a GPS locator to determine geographic location of the battery.

Referring to FIG. 12, in an exemplary embodiment, the master control module may also be read by a computer and/or separate monitoring device by either a wired or wireless connection, with or without an internet data sharing protocol. Exemplary wired connections include, but are not limited too, a CAT 5 Ethernet cable, a USB cable, or FM or other radio signal transmission over the charger cables, ultimately read and monitored by a computer and/or a module within the charger/de-sulfator. Exemplary wireless connections include but are not limited too, a Wi-Fi, Bluetooth, a cell phone protocol or other wireless connection. The wireless system may be capable of transmitting a condition status to a localized “hotspot” or receiver, either upon a monitored malfunction event, or on a periodic basis, for example. While the system is designed to be utilized on a motive type of battery, with accessible individual cells, it is understood that the device may also work equally well on battery systems that use individual batteries combined together as a battery pack, regardless of the voltage array, or simply on an individual battery.

In some exemplary embodiments, a conductive “electrolyte” sensing probe may be installed on the individual battery cell and may be in substantially constant contact with the battery cell electrolyte. The standard probe may be “passive,” that is supply data measurements to another device without an onboard memory system. An additional passive slave “terminal” sensing device may attach to the terminals of the cell, and may not contact the cell electrolyte. The probe may also provide a means to allow the removal or introduction of acid electrolyte solutions to adjust the acidity of the electrolyte solution, or simply water the battery. In some exemplary embodiments, a separate clamp, transducer or other sensing device that provides a raw data input source may be used.

Additional optional modules may be used such as, for example and without limitation: 1) a “Carbon Tracking Module,” 2) a GPS Locator Module, 3) a Vibration Monitoring Module, 4) Historical Data Module, and/or 5) a Maintenance or Operational Data Module.

In some exemplary embodiments, the master/slave and/or smart probe system may incorporate software systems, such as 1) A software system imbedded into the monitoring circuitry, herein referred to as “firmware,” and/or 2) an “operational” software system running on a computer that reads the data from the module, processes it, stores it and/or provides a graphical user interface to manipulate the data, or simply export the raw data to a commercially available database, spreadsheet or other software program. While the operational software may be primarily designed as a transfer program to read raw data from the SRO module or the smart probe and export it in a form readable by a commercially available database, spreadsheet or other data management software program, it may also allow the user to set operational and monitoring parameters that are then sent to, and are intended to modify the firmware monitoring parameters.

An exemplary SRO system may provide the raw data to determine the charger/battery electrical serviceability index, the charge return factor, the periodic equalization strategy, the charge completion profile, the individual cell temperature, voltage, electrolyte fluid level, impedance, and MAC data to modify existing charger or other ancillary system profiles.

Exemplary SRO systems may include several quantified comparison value raw data inputs, which may be further developed into mathematical comparative value indices. The raw data source values may include one or more of the following:
CV-Voltage, (CV): The individual cell voltage measured across the cell terminals or from electrolyte to electrolyte of adjacent cells.
CV-P: The cell voltage measured from the electrolyte to the positive terminal post.
CV-N: The cell voltage measured from the electrolyte to the negative terminal post.
CT-Temperature, (CT): The individual cell temperature measured from the electrolyte.
AH-Battery Amp-Hours: The amount of amp-hours restored by the battery during re-charging, or the amp-hours delivered during discharge.
CI—Cell Impedance, the amount of internal resistance of the battery or cell when measured from the positive to negative cell terminal post, or when measured from electrolyte to electrolyte of adjacent cells.
CI-P: The Cell impedance when measured from the electrolyte to the positive terminal post.
CI-N: The Cell impedance when measured from the electrolyte to the negative terminal post.
CMAC—Cell Molecular Acid Conductivity, the digitally measured increase or decrease of acid molecules in solution.
CEFL—Cell Electrolyte Fluid Level, the digitally measured increase or decrease in the individual cell electrolyte fluid level.
C-DD: Cell Delta Discharge, which is the change in cell metrics during an applied discharge load from the battery.
C-DC: Cell Delta Charge, which is the change in cell metrics during an applied Charge to the battery.
C-DD: Cell Delta De-Sulfation, which is the change in cell metrics during an applied de-sulfation process.
C-VIB: Cell Vibration, which is the measured level of vibration experienced by the cell.
C-ESI: Cell Electrical Serviceability Index, which is the electrical efficiency factor of the cell.
SRO Module Hardware (Exemplary embodiment, not to be considered limiting)

Some example embodiments may include a printed circuit board approximately 6 inches wide by approximately 12 inches long.

Some example embodiments may include in and/or out connectors such as terminal type wire connections. Some example Batt-Smart systems may be powered by the battery power of the battery it is attached to. Some example SRO facilities systems may be powered by line voltage.

In some example embodiments, individual cell electrical channels (conductors) using an electrolyte probe may include one or more of the following: 1 voltage channel, 1 temperature channel, 1 electrolyte level channel, 1 impedance channel, and/or 1 MAC channel. 1 Cell interconnecting link channel for the CV-P, CV-N, CI-P and CI-N cell metrics may be used in conjunction with the standard electrolyte and/or smart probes. Some example embodiments may include one or more of the following terminal connections using a direct connection to the cell terminals: 1 voltage channel, 1 temperature channel, 1 impedance channel, 1 electrolyte fluid level, and/or 1 MAC channel. Any combination of electrolyte probes or terminal connectors may be used.

SRO monitoring module PCB electrical channels may include one or more of the following, for example:
A positive terminal clamp to provide a positive battery reference signal and a negative terminal clamp to provide a negative battery reference signal.
A pair of AC Voltage conductors to monitor the battery charger voltage to allow the calculation of AC Device Watts and Volt Amps.
8 Digital Turn Off (DTO) channel outputs.
2 or more SPI or equivalent input/output device channels.
More than one external instrument output that display SRO cell/battery metrics on an external display.
1 input channel for an ammeter shunt, hall effect sensor or equivalent measuring device to read DC amp-hours in and out of the battery.
1 input channel for an ammeter shunt, Hall effect sensor or equivalent measuring device to read AC amp-hours into the battery charger. This is used to calculate Watts or Volt Amps consumed by the battery charger or other AC line based ancillary devices.
1 two-wire input channel for PCB supply voltage and ground.
1 each separate CAT 5, RS 232, infrared, opto-isolated, wired or wireless channel for the output of data.
1, two or more wire input from each probe or terminal connection of each Individual Cell channels as required to read cell or battery input metric values for the number of cells/batteries the operator chooses to monitor. For example, a 48-volt battery may require 24 discrete channels.
1 two-wire annunciator reset channel.
1 two-wire operational/historical/maintenance module input/output.

An exemplary embodiment of a PCB hardware device may include an amperage-measuring device located around the battery cable or battery cell interconnect link, an analog to digital converter, a memory device, a processing device, a computer communications port, a frequency generator, a programmable gate array, a multiplexer, a frequency transmission device that may be either wired, wireless, or frequency modulated over the battery cables, a power supply converter, and/or an SPI based expansion port.

An exemplary embodiment may include: 1) a multi-channel, individual cell monitoring and comparison device that monitors cell metrics, 2) a battery mounted hardware device to receive, time stamp and/or store the data, 3) an array of optional modules to read, process and/or store Historical, Operational, Vibration, and/or Maintenance data, 4) an RFID or “Pinger” device, 5) a GPS Locator device, and/or 6) a method to transfer the data to a computer for ultimate import into a commercially available statistical software analysis program.

In some exemplary embodiments, a processor chip on the Master Control Module or the smart probe may be programmed with firmware that establishes the thresholds of certain cell metrics. The firmware may be programmed and sent to the chip by the computer based operational software and graphical user interface, GUI. Once the cell comparison parameters are established and set, the GUI will send the data to the master control module or smart probe system firmware establishing the operational raw data parameters of the system.

An exemplary SRO system may include voltage inputs from individual cells to the master control module that read “Cell Voltage” V1. One “Terminal” method is from a mechanical attachment of a wire from the master control module to the positive terminal of the cell, then referenced to battery ground or the cell negative terminal. The cell voltage readings may be stored in the memory of the master control module, and then downloaded to the operational software upon demand for the data. The cell positions may be read beginning from the last cell in the array, the cell providing the final negative ground to the entire battery cell array, or the individual cell negative terminal if necessary. The cell voltage of cell #1 may be V1, the cell voltage of cell #2 will be V2, and so on for additional cell positions.

An alternative method may utilize an electrolyte probe mounted on the battery cell. In some example embodiments, the probe to be placed in a sequential manner with respect to the other cell probes. Using this method, the probes may read from cell electrolyte to cell electrolyte, then referenced to battery ground, of adjacent cells in a series connected cell array.

An exemplary voltage measuring process may proceed as follows:

Cell #1 Value: The probe attached to the cell position #1 positive terminal may read the cell voltage of cell #1. Cell #1=V1, where V1 is the voltage read at the terminal (or the electrolyte) of cell #1.

Cell #2 Value: The probe attached to the cell position #2 positive terminal may read the cumulative voltage of cell voltage #1 and cell voltage #2. To determine the cell voltage of cell #2, subtract the voltage of cell #1 from the voltage reading of cell #2. The resulting value is the voltage reading of cell #2. Cell #2=V2−V1, where V2 is the voltage read at the terminal of cell #2 and V1 is the voltage read at the terminal of cell #1.

Cell #3 Value: The probe attached to the cell position #3 positive terminal may read the cumulative voltage of cell voltage #1, cell voltage #2 and cell voltage #3. To determine the cell voltage of cell #3, subtract the voltage of cell #3 from the sum of cell voltage #1 and cell voltage #2. The remainder is the cell voltage of cell #3. Cell #3=V3−(V2+V1).

Additional cell voltages (VN) may be determined using the same process of subtracting the desired cell voltage cumulative voltage reading, from the sum of the preceding sequential cell voltages.

As an alternative to terminal read voltage, Cell Voltage V1, V2, V3, etc., may be read by the attachment of a wire from the master control module to a probe that is in contact with the electrolyte. The voltage may be read by the probe contact in relation to battery ground. The determination of the individual cell voltage is in the same mathematical manner as the terminal probe, read sequentially, and each additional cumulative cell reading is subtracted from any preceding values to determine the remaining cell voltage.

Another alternative example method may utilize an electrolyte probe mounted on the battery cell in conjunction with the an advanced positioning system process that may allow the electrolyte probes for a plurality of cells to be placed in any order with respect to the other cell probes. Using this method, the probes may read from cell electrolyte to cell electrolyte, then referenced to battery ground, of adjacent cells in a series connected cell array. Some example embodiments may be configured to determine the order of individual probes based upon the voltage detected and, when the collected data is processed, the data may be automatically identified with the correct battery cell. In other words, any probe may be inserted into any cell and the advanced positioning system may automatically determine which cell position the probe is located within.

In some example embodiments, when measuring cell voltage CV-P or CV-N, one probe may be installed in the electrolyte and another probe may be attached to the corresponding positive or negative cell terminal Both voltage probes or clamps may be read while isolated from the other probes or clamps used in the SRO at the moment the voltage is read.

In some example embodiments, when using smart probe, the individual voltages may be stored in the electronic circuitry of the probe. The individual voltages may be determined in the same manner as the terminal based voltage sensor and may be read sequentially.

An exemplary SRO system may include an individual “Cell Temperature” T1, which may be measured by a temperature measuring integrated circuit, a thermistor, a resistive temperature device (RTD) or other temperature affected device, on individual cells or probes that are fitted to the cells. The downward modification of measured cell voltage V1 by the temperature affected device, as referenced to the parallel Cell Voltage V1 input to the PCB, may be the indicated temperature of the cell, T1. As the temperature rises in the battery cell, the measured cell voltage input V1 into the temperature compensated device may be modified as the electrolyte (or the battery terminal depending on the sensor mounting options) temperature increases, producing a modified, typically lower, voltage input to the master control module T1, for each individual cell or battery. Thus, when the Temperature Voltage signal T1 is referenced to the parallel Cell Voltage V1 signal, the differential voltage may be the indication of the cell temperature. Cell temperature of cell #1 will be T1, the cell temperature of cell #2 will be T2, and so on for additional cell positions.

The present disclosure contemplates that cell vibration caused by operational use of the cell/battery may result in physical damage to the internal connections of the battery raising the impedance and, if exceptionally adverse, may cause the failure of the cell or battery. The measurement and trend analysis of battery vibration levels may allow operators to identify the source of excess vibration forces and take remedial actions to minimize the affects of applied vibration. The minimization of applied vibration will increase the operational life of the battery. In some exemplary embodiments, Cell/Battery vibration levels may be measured by the use of a commercially available accelerometer, velometer (a device that read acceleration as the device goes through “zero” on the sine wave), g force measuring device, and/or other commercially available force measurement devices. The data collected may be processed and stored in the permanent historical recordkeeping module.

The present disclosure contemplates that cell impedance may be determined by applying an alternating current source, of known frequency, voltage, and amperage to the cell, then measuring the output and comparing the input and output values. This differential may be a measure of the internal resistance or impedance, caused by sulfation and/or mechanical interruptions between the plates of the battery. For an established state of charge and temperature, low impedance typically means low internal resistance and high probable battery output power. For an established state of charge and temperature, high impedance typically means high internal resistance and low probable output power.

In some exemplary embodiments, with respect to the SRO system circuitry, impedance may be determined by applying an external alternating current, the source of which can be an alternating current (AC) power supply integrated into the master control board, or a DC pulse width modulated generated current. Conductors may transfer the impedance readings from each individual cell to the master control module. The smart probe may store the impedance readings within the probe memory. Once the master control module or the smart probe have stored the raw data, the data may remain in storage until the data is transferred. In the event impedance reaches a level outside of the prescribed parameters established in the firmware, the alarm system may activate the annunciator notifying the operator that service should be performed on the battery.

In some example embodiments, when measuring cell impedance CI-P or CI-N, one probe may be installed in the electrolyte and another probe or clamp may be attached to the corresponding positive or negative cell terminal Both impedance probes or clamps may be read while isolated from the other probes or clamps used in the SRO system at the moment the impedance is read.

In some example embodiments, MAC may be determined by applying an alternating or direct current source directly to the electrolyte solution, of known frequency, voltage and amperage, then measuring the output and comparing the input and output values. This differential is a measure of the resistance of the electrolyte of each cell resulting from the measurable concentration of the acid molecules in solution.

In some example embodiments, software may be designed so that the system will not record data unless some minimum level of amps or a voltage change is being sensed by the system. This may prevent the SRO system from collecting null values from an inoperative battery.

An exemplary SRO system may be configured to log date pertaining to a variety of parameters. For example, one output may include the electrical efficiency of the battery charging process and/or amp/hours being restored to the battery. Another example output may include the run time of the battery and/or a time to remove amp/hours from the battery. Another example output may include cell performance date for individual cells during operation in the real time environment. Cell performance subcategories may be evaluated by the use of a functional coefficient derived from several methodologies that include but are not limited to cell metrics collected from 1) a load analysis component derived by the correlation of a known discharge rate to voltage drop, ratio analysis, 2) a charging temperature of the battery electrolyte to sulfation, ratio analysis, 3) a ratio analysis of the voltage differential between individual cells of a sequential cell array typical in a motive battery, 4) peak amperage to RMS amperage ratio analysis resulting from the pulse width modulated signal developed during a de-sulfation process, 5) cell impedance analysis, 6) MAC analysis, 7) electrolyte fluid level data, 8) Q values, and/or 9) any combination of the above. Another example output may include data pertaining to cell vibration level during normal operation.

As used herein, Electrical Serviceability Index may refer to the amount of charger electrical consumption used to recharge the battery, divided by the number of amp-minutes or hours delivered by the battery during discharge. The Charge Return Factor is the number of amp-hours returned to the battery divided by the number of amp-hours delivered by the battery during discharge.

Individual cells may be sampled and/or compared during re-charging after they had been discharged during normal operation. The cells may begin to charge and the data logger may begin to record and time stamp, 1) milli-volts from the shunt (clamp meter), “Amperage,”; 2) battery or individual cell volts, “CV, CV-P, CV-N,”; 3) battery or individual cell temperature, such as electrolyte temperature, “T1,” 4) individual cell or combined battery impedance, “CI, CI-P, CI-N,” 5) individual cell MAC, 6) outside air temperature “OAT,” 7) the presence or lack of voltage V1 indicating the presence or lack of electrolyte contacting the probe in the cell, or 8) any other cell metrics. An exemplary facility system may also read and record the wattage used by the charger to restore amp-hours (minutes) to the battery. An exemplary facility system may also read, record and compare any or all of the above cell metric values, determine optimum values within that comparison, and utilize these relationships to provide command and control functions to perform battery optimization functions.

In some exemplary embodiments, as the sampling is completed it may be saved to a memory register in either master control module or the smart probe, as a digital value. The facility system may transfer the data directly to the computer. Once the test is completed, the data may be down loaded and a sampling band-width is selected and stored within a commercially available computer database or spreadsheet software program.

In some exemplary embodiments, the system may base the start and end cycle on the state of the prime cell voltage or a Q value. Since the system may include a voltage-sampling device, a change in the voltage of the master cell (Vm) may be considered as the beginning of the sampling process and the lack of change may signal the end of the sampling event. The prime cell or prime battery in a battery array, may be a cell (battery) that is chosen as an index cell for reference purposes. The prime cell or battery may be chosen based on cell/battery location and/or performance characteristics. The prime cell in one example may be chosen because of it's physical location and resultant ease of access. In another example, the prime cell may be chosen because it may be the weakest or strongest performing cell or battery in the array.

In some exemplary embodiments, the firmware may sample and read only the master cell on a continuous basis, a change in selected cell metrics or Q value, either upwards or downwards in excess of an established value may trigger the firmware to “awaken” from an idle resting state and begin sampling.

In some exemplary embodiments, individual cells may be sampled for three different voltages (CV-1, CV-P and CV-N), Cell Electrolyte Level (C-EFL), three different cell impedance values (CI, CI-P, CI-N), Cell Temperature (CT), C-MAC, and/or other cell metrics as previously described.

In some exemplary embodiments, the firmware for a facility system may differ in that it may only facilitate the conversion of raw analog data into computer friendly digital data, which may then be stored in the computer itself.

An exemplary GUI software system may read the stored raw data from the memory chip located in the smart battery control module and/or the smart probe. The operational system may collect and/or export the raw data in a format that is accepted by a commercially available database, spreadsheet, or other statistical analysis software program.

U.S. patent application Ser. No. 12/590,466, filed Nov. 9, 2009, titled “Lead Acid Battery De-Sulfation,” which is incorporated by reference, describes battery de-sulfation methods and systems which may be used in connection with example embodiments of the present disclosure.

All patents, patent application publications, and any other documents discussed herein are expressly incorporated by reference.

As used herein, “range of optimality” may refer to a desired operating range of a parameter. As used herein, a predetermined parameter limit may be “exceeded” when a measured value falls above or below a desired range. As used herein, “battery-mounted” refers to mounting on or near a battery. As used herein, “permanent” refers generally to non-volatile storage, but does not necessarily require that such storage is non-erasable.

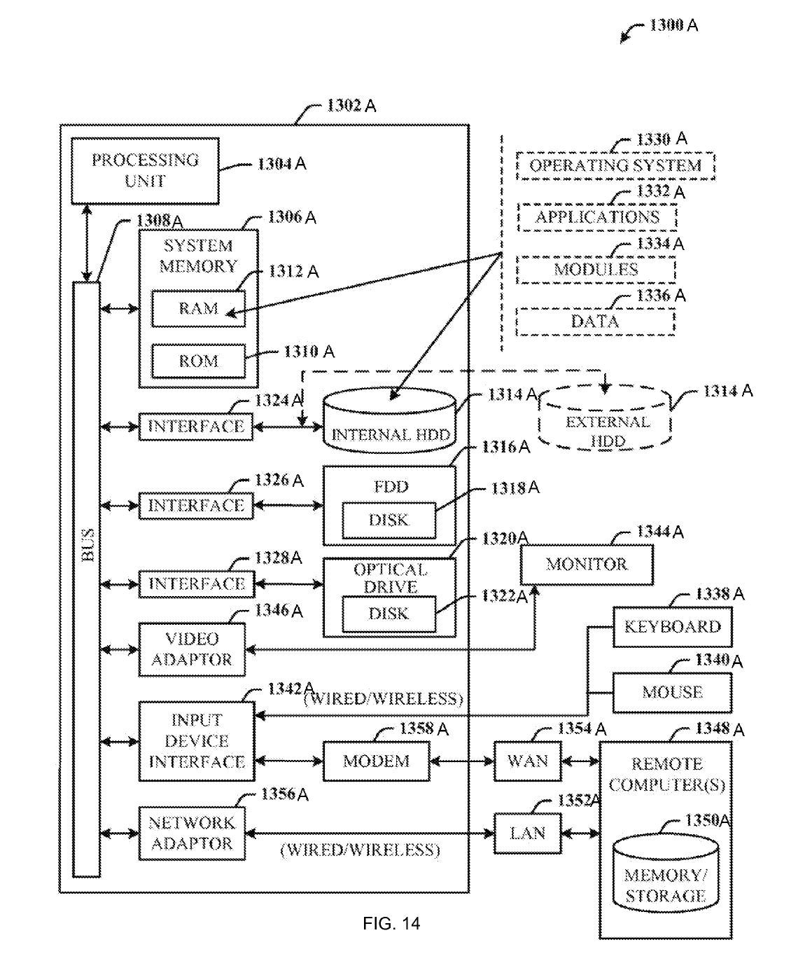

FIG. 14 includes a block diagram of an example computer system that may be utilized (wholly or in part) in connection with example embodiments according to the present disclosure. In order to provide additional context for various aspects of the present disclosure, the following discussion provides a brief, general description of an example computing environment 1300A. Those skilled in the art will recognize that the various aspects of the present disclosure may be implemented in combination with other program modules and/or as a combination of hardware and software.

Generally, program modules include routines, programs, components, data structures, etc., that perform particular tasks or implement particular data types. Moreover, those skilled in the art will appreciate that the methods according to the present disclosure may be practiced with other computer system configurations, including single-processor or multiprocessor computer systems, minicomputers, mainframe computers, as well as personal computers, hand-held computing devices, microprocessor-based or programmable customer electronics, and the like, each of which can be operatively coupled to one or more associated devices.

Some aspects of the present disclosure may also be practiced in distributed computing environments where certain tasks are performed by remote processing devices that are linked through a communications network. In some example distributed computing environments, program modules may be located in local and/or remote memory storage devices.

An example computer may include a variety of computer-readable media. Computer-readable media may include any available media that can be accessed by the computer and includes both volatile and non-volatile media, as well as removable and non-removable media. By way of example, and not limitation, computer-readable media may comprise computer storage media and communication media. Computer storage media may include volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

An example computing environment 1300A for implementing various aspects includes a computer 1302A, which may include a processing unit 1304A, a system memory 1306A and/or a system bus 1308A. The system bus 1308A may couple system components including, but not limited to, the system memory 1306A to the processing unit 1304A. The processing unit 1304A can be any of various commercially available processors. Dual microprocessors and other multi-processor architectures may also be employed as the processing unit 1304A.

The system bus 1308A can be any of several types of bus structures that may further interconnect to a memory bus (with or without a memory controller), a peripheral bus, and/or a local bus using any of a variety of commercially available bus architectures. The system memory 1306A may include read only memory (ROM) 1310A and/or random access memory (RAM) 1312A. A basic input/output system (BIOS) may be stored in a non-volatile memory 1310A such as ROM, EPROM, EEPROM. BIOS may contain basic routines that help to transfer information between elements within the computer 1302A, such as during start-up. The RAM 1312A can also include a high-speed RAM such as static RAM for caching data.

The computer 1302A may further include an internal hard disk drive (HDD) 1314A (e.g., EIDE, S ATA), which may also be configured for external use in a suitable chassis, a magnetic floppy disk drive (FDD) 1316A (e.g., to read from or write to a removable diskette 1318A), and/or an optical disk drive 1320A (e.g., reading a CD-ROM disk 1322A or, to read from or write to other high capacity optical media such as the DVD). The hard disk drive 1314A, magnetic disk drive 1316A, and/or optical disk drive 1320A can be connected to the system bus 1308A by a hard disk drive interface 1324A, a magnetic disk drive interface 1326A, and an optical drive interface 1328A, respectively. The interface 1324A for external drive implementations may include at least one or both of Universal Serial Bus (USB) and IEEE 1394 interface technologies. Other external drive connection technologies are within the scope of the disclosure.

The drives and their associated computer-readable media may provide nonvolatile storage of data, data structures, computer-executable instructions, and so forth. For the computer 1302A, the drives and media may accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in an example operating environment, and further, that any such media may contain computer-executable instructions.

A number of program modules can be stored in the drives and RAM 1312A, including an operating system 1330A, one or more application programs 1332A, other program modules 1334A, and/or program data 1336A. All or portions of the operating system, applications, modules, and/or data can also be cached in the RAM 1312A. It is to be appreciated that various commercially available operating systems or combinations of operating systems may be utilized.

A user can enter commands and information into the computer 1302 through one or more wired/wireless input devices, e.g., a keyboard 1338A and a pointing device, such as a mouse 1340A. Other input devices may include a microphone, an IR remote control, a joystick, a game pad, a stylus pen, touch screen, or the like. These and other input devices are often connected to the processing unit 1304A through an input device interface 1342A that is coupled to the system bus 1308A, but can be connected by other interfaces, such as a parallel port, an IEEE 1394 serial port, a game port, a USB port, an IR interface, etc.

A monitor 1344A or other type of display device may also connected to the system bus 1308A via an interface, such as a video adapter 1346A. In addition to the monitor 1344A, a computer typically includes other peripheral output devices, such as speakers, printers, etc.

The computer 1302A may operate in a networked environment using logical connections via wired and/or wireless communications to one or more remote computers, such as a remote computer(s) 1348A. The remote computer(s) 1348A can be a workstation, a server computer, a router, a personal computer, portable computer, microprocessor based entertainment appliance, a peer device, and/or other common network node, and/or may include many or all of the elements described relative to the computer 1302, although, for purposes of brevity, only a memory/storage device 1350A is illustrated. The logical connections depicted include wired/wireless connectivity to a local area network (LAN) 1352A and/or larger networks, e.g., a wide area network (WAN) 1354A. Such LAN and WAN networking environments are commonplace in offices and health care facilities, and facilitate enterprise-wide computer networks, such as intranets, all of which may connect to a global communications network, e.g., the Internet.

When used in a LAN networking environment, the computer 1302A may be connected to the local network 1352A through a wired and/or wireless communication network interface or adapter 1356A. The adaptor 1356A may facilitate wired or wireless communication to the LAN 1352A, which may also include a wireless access point disposed thereon for communicating with the wireless adaptor 1356A.

When used in a WAN networking environment, the computer 1302A can include a modem 1358A, or may be connected to a communications server on the WAN 1354A, or may have other devices for establishing communications over the WAN 1354A, such as by way of the Internet. The modem 1358A, which can be internal or external and a wired or wireless device, may be connected to the system bus 1308A via the serial port interface 1342A. In a networked environment, program modules depicted relative to the computer 1302A, or portions thereof, can be stored in the remote memory/storage device 1350A. It will be appreciated that the network connections shown are exemplary and other means of establishing a communications link between the computers can be used.

The computer 1302A is operable to communicate with any wireless devices or entities operatively disposed in wireless communication, e.g., a printer, scanner, desktop and/or portable computer, portable data assistant, communications satellite, any piece of equipment or location associated with a wirelessly detectable tag, and/or telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.1a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can operate in more than one band (e.g., dual band), so the networks can provide real-world performance similar to the basic 10BaseT wired Ethernet networks used in many offices.

The attached figures illustrate various example embodiments and components thereof, including some optional components. The figures are merely exemplary, and should not be considered limiting in any way. One of skill in the art will understand that the schematically depicted illustrated embodiments may include appropriate circuitry, connectors, communications links, and the like.

While exemplary embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages may exist even though they may not have been explicitly discussed herein.

What is claimed is:

1. A method of servicing a battery, the method comprising:
connecting a battery to a battery servicing apparatus, the battery servicing apparatus including an automated electronic system configured to gather data associated with at least one battery cell and to direct operation of at least one ancillary device, the automated electronic system being operatively coupled to at least one of at least one probe at least partially immersed in electrolyte of the at least one battery cell and at least one clamp operatively coupled to a plate of the at least one battery cell, the automated electronic system including a memory configured to store data associated with the at least one battery cell and a processing unit configured to direct operation of the at least one ancillary device, the at least one ancillary device being configured to act on the at least one battery cell;
measuring, by the automated electronic system, a first set of metrics associated with the at least one battery cell;
selecting, automatically by the automated electronic system, at least one maintenance action based at least in part upon the measured first set of metrics;
directing, by the automated electronic system, performance of the at least one maintenance action on the at least one battery cell by the ancillary device; and
measuring, by the automated electronic system, a second set of metrics associated with the at least one battery cell after performance of the at least one maintenance action.

2. The method of claim 1, further comprising determining, by the automated electronic system, whether further maintenance actions should be performed on the at least one battery cell based at least in part upon the second set of metrics.

3. The method of claim 2, further comprising
directing, by the automated electronic system, performance of further maintenance actions on the at least one battery cell; and
measuring, by the automated electronic system, a third set of metrics associated with the at least one battery cell after performance of the further maintenance actions.

4. The method of claim 1, wherein performing the at least one maintenance action on the at least one battery cell includes sending at least one control signal to the at least one ancillary device.

5. The method of claim 4, wherein the at least one ancillary device comprises at least one of a charger, de-sulfator, a load tester, and an acid adjustment system.

6. The method of claim 1, further comprising
storing at least one command corresponding to the at least one maintenance action;
transmitting the command from the automated electronic system to a second automated electronic system; and
executing the transmitted command, by a second automated electronic system, to direct performance of the at least one maintenance action on a second battery located at the remote location.

7. The method of claim 1, further comprising, after measuring a first set of metrics, determining, by the automated electronic system, whether any of the first set of metrics corresponds to an out of specification condition.

8. The method of claim 1, wherein the first set of metrics and the second set of metrics each include at least one of cell voltage, positive plate voltage, negative plate voltage, cell electrolyte temperature, cell impedance, positive plate impedance, negative plate impedance, cell electrolyte molecular acid concentration, and cell electrolyte level.

9. The method of claim 1, wherein the step of directing performance of the at least one maintenance action on the at least one battery cell is performed automatically by the automated electronic system.

10. The method of claim 1, wherein selecting the at least one maintenance action includes selecting the at least one maintenance action based at least in part upon the measured first set of metrics and based at least in part upon a previous set of metrics obtained in connection with a previous maintenance action performed on the at least one battery cell.

11. A method of maintaining a battery, the method comprising:
connecting a battery to a battery servicing apparatus, the battery servicing apparatus including an automated electronic system configured to gather data associated with at least one battery cell and to direct operation of at least one ancillary device, the automated electronic system being operatively coupled to at least one of at least one probe at least partially immersed in electrolyte of the at least one battery cell and at least one clamp operatively coupled to a plate of the at least one battery cell, the automated electronic system including a memory configured to store data associated with the at least one battery cell and a processing unit configured to direct operation of the at least one ancillary device, the at least one ancillary device being configured to perform at least one battery maintenance action on the at least one battery cell;
measuring, by the automated electronic system, the data, the data pertaining to at least one parameter associated with the at least one battery cell;
recording, by the automated electronic system, the data; and
analyzing, automatically by the automated electronic system, the data to determine whether an out of specification condition is associated with the at least one battery cell.

12. The method of claim 11, further comprising transmitting, by the automated electronic system, at least one command to the at least one ancillary device; wherein the at least one command directs the at least one ancillary device to perform the at least one battery maintenance action on the at least one battery cell.

13. The method of claim 12, wherein the ancillary device is configured to perform at least one of charging, load testing, de-sulfating, and acid-adjusting.

14. The method of claim 13, further comprising:
connecting the battery to the at least one ancillary device; and
performing at least one of charging, load testing, de-sulfating, and acid-adjusting;
wherein whether charging, load testing, de-sulfating, or acid-adjusting is performed is determined at least in part based upon the measured data.

15. The method of claim 12, wherein transmitting the at least one command includes transmitting the at least one command via at least one of a wireless connection and a wired connection.

16. The method of claim 12, wherein transmitting the at least one command includes connecting the battery to the at least one ancillary device using at least one cable and transmitting the at least one command via the cable.

17. The method of claim 12, wherein the automated electronic device is mounted adjacent the at least one battery; and wherein the automated electronic device is configured to transmit commands pertaining to battery maintenance actions include normal battery charging.

18. The method of claim 11, further comprising calculating a functional coefficient for the at least one battery cell, wherein the functional coefficient is calculated based at least in part upon the measured data.

19. The method of claim 18, wherein the functional coefficient is calculated by dividing amps removed from the at least one battery cell by amps restored to the at least one battery cell.

20. The method of claim 18, wherein calculating the functional coefficient includes evaluating at least one of amps removed from the at least one battery cell and amps restored to the at least one battery cell.

21. The method of claim 18, wherein calculating the functional coefficient includes evaluating at least one of an increasing voltage and a decreasing voltage of the at least one battery cell.

22. The method of claim 11, further comprising determining a molecular acid concentration of the electrolyte of the at least one battery cell including
measuring a resistance of the electrolyte;
measuring a temperature of the electrolyte; and
calculating the molecular acid concentration based at least in part upon the measured resistance and the measured temperature.

23. The method of claim 22, wherein determining the molecular acid concentration further comprises measuring an impedance of the at least one battery cell; and wherein calculating the molecular acid concentrations further comprises calculating the molecular acid concentration based at least in part upon the measured resistance, the measured temperature, and the measured impedance.

24. The method of claim 11, further comprising determining a molecular acid concentration of the electrolyte of the at least one battery cell including
measuring an impedance associated with the at least one battery cell;
measuring a temperature including at least one of an ambient temperature and an electrolyte temperature of the at least one battery cell; and
determining the molecular acid concentration of the electrolyte of the at least one battery cell based at least in part on a known relationship between the measured impedance and the measured temperature.

25. The method of claim 24, wherein the known relationship was determined using a test battery substantially similar to the battery.

26. The method of claim 24, wherein measuring the impedance includes measuring the impedance using two of the clamps operatively connected to the plates of the battery cell.

27. The method of claim 11, wherein measuring the data pertaining to the at least one parameter includes measuring an impedance of the at least one battery cell includes applying electrical signals to the at least one battery cell using at least one adjacent cell probe at least partially immersed in electrolyte of at least one adjacent battery cell.

28. The method of claim 11, wherein measuring the data pertaining to the at least one parameter includes measuring an impedance between the at least one probe and the at least one clamp, wherein the at least one clamp is operatively connected to a positive plate of the battery cell.

29. The method of claim 11, wherein measuring the data pertaining to the at least one parameter includes measuring an impedance between the at least one probe and the at least one clamp, wherein the at least one clamp is operatively connected to a negative plate of the battery cell.

30. The method of claim 11, wherein analyzing the data includes calculating an electrical serviceability index associated with at least one of the at least one battery cell and the battery; wherein calculating the electrical serviceability index includes comparing an amount of energy used to power a battery charger with an amount of energy delivered by the at least one of the at least one battery cell and the battery.

31. The method of claim 11, wherein measuring the data includes measuring data pertaining to a plurality of individual cells of the battery.

32. The method of claim 11, wherein the at least one probe includes at least two individual conductive elements in electrical contact with the electrolyte.

33. The method of claim 32,
wherein the at least one parameter includes at least one of acid concentration of the electrolyte and impedance of the electrolyte; and
wherein the at least one parameter is measured using the at least two individual conductive elements.

34. The method of claim 11, wherein the at least one probe includes at least one conductive element in electrical contact with the electrolyte and at least one pipette in fluidic communication with the electrolyte.

35. The method of claim 11,
wherein the automated electronic system is operatively coupled to both the at least one probe at least partially immersed in electrolyte of the at least one battery cell and the at least one clamp operatively coupled to the plate of the at least one battery cell; and
wherein measuring the data, the data includes measuring the at least one parameter using both the at least one probe and the at least one clamp.

36. The method of claim 35, wherein the at least one probe includes at least two individual conductive elements in electrical contact with the electrolyte.

37. A method of servicing a battery, comprising:
connecting a battery to a battery servicing apparatus, the battery servicing apparatus including an automated electronic system configured to gather data associated with at least one battery cell and to direct operation of at least one ancillary device, the automated electronic system being operatively coupled to at least one of at least one probe at least partially immersed in electrolyte of the at least one battery cell and at least one clamp operatively coupled to a plate of the at least one battery cell, the automated electronic system including a memory configured to store data associated with the at least one battery cell and a processing unit configured to direct operation of the at least one ancillary device, the at least one ancillary device being configured to perform at least one battery maintenance action on the at least one battery cell;
measuring, automatically by the automated electronic system, a first set of data associated with a plurality of individual cells of the battery during at least one of normal operation and testing operation;
identifying, automatically by the automated electronic system and based at least in part upon analysis of the first set of data, a first set of maintenance actions to be performed on the battery;
formulating, automatically by the automated electronic system, a first set of commands corresponding to the first set of maintenance actions; and
executing, by the automated electronic system, the first set of commands to direct the at least one ancillary device to perform the first set of maintenance actions on the battery.

38. The method of claim 34, wherein the first set of data for one of the plurality of individual cells includes at least one of cell voltage, positive plate voltage, negative plate voltage, cell electrolyte temperature, cell impedance, positive plate impedance, negative plate impedance, cell electrolyte molecular acid concentration, and cell electrolyte level.

39. The method of claim 34, further comprising exporting the first set of commands to a remote computing device.

40. The method of claim 34, further comprising
measuring, automatically by the automated electronic system, a second set of data associated with the plurality of individual cells of the battery after executing the first set of commands;
identifying, automatically by the automated electronic system and based at least in part upon analysis of the second set of data, a second set of maintenance actions to be performed on the battery;
formulating, automatically by the automated electronic system, a second set of commands corresponding to the second set of maintenance actions; and
executing, by the automated electronic system, the second set of commands to direct the at least one ancillary device to perform the second set of maintenance actions on the battery.

41. The method of claim 40, wherein at least one maintenance action in the second set of maintenance actions is identified based upon a comparison between the second set of data and the first set of data.

42. The method of claim 37, wherein measuring a first set of data includes sensing at least one parameter using the at least one probe.

43. The method of claim 37, wherein the first set of commands includes at least one of an ancillary device identification, an ancillary device voltage level, an ancillary device amperage level, an ancillary device peak-to-peak amperage level, an ancillary device peak-to-peak voltage level, an ancillary device impedance level, an ancillary device alarm set point, and an ancillary device run time.

44. The method of claim 37, wherein the connecting operation includes associating a plurality of the probes with a respective plurality of the individual cells in a first order and automatically, by the automated electronic system, detecting the first order; and
wherein the method further comprises
disconnecting the battery maintenance apparatus from the battery; and
re-connecting the battery maintenance apparatus to the battery including associating the plurality of the probes with the respective plurality of the individual cells in a second order, the second order being different from the first order, and automatically, by the automated electronic system, detecting the second order.

45. The method of claim 37, wherein the connecting operation includes associating a plurality of the clamps with a respective plurality of the individual cells in a first order and automatically, by the automated electronic system, detecting the first order; and
wherein the method further comprises
disconnecting the battery maintenance apparatus from the battery; and
re-connecting the battery maintenance apparatus to the battery including associating the plurality of the clamps with the respective plurality of the individual cells in a second order, the second order being different from the first order, and automatically, by the automated electronic system, detecting the second order.
